(19) United States
(12) Patent Application Publication
(10) Pub. No.: US 2025/0292083 A1
(43) Pub. Date: Sep. 18, 2025

(54) System and Method for Accurate Natural Language Processing

(71) Applicant: Acurai, Inc., Brooklyn, NY (US)

(72) Inventor: Michael Wood, Wilton Manors, FL (US)

(73) Assignee: Acurai, Inc., Brooklyn, NY (US)

(21) Appl. No.: 19/074,349

(22) Filed: Mar. 8, 2025

Related U.S. Application Data
(60) Provisional application No. 63/566,107, filed on Mar. 15, 2024.
(60) Provisional application No. 63/668,678, filed on Jul. 8, 2024.
(60) Provisional application No. 63/716,119, filed on Nov. 4, 2024.
(60) Provisional application No. 63/750,084, filed on Jan. 27, 2025.
(60) Provisional application No. 63/761,053, filed on Feb. 20, 2025.

(51) Int. Cl. G06N 3/08

(52) U.S. Cl. CPC G06N 3/08

(57) ABSTRACT

Systems and methods of accurate Natural Language Processing (NLP) for high-level NLP processes using novel pipelines of low-level NLP processes are disclosed, including a method for creating 100% accurate embodiments of the low-level NLP processes, resulting in 100% accurate implementations of the pipelined high-level NLP processes. The method for creating 100% accurate low-level NLP embodiments is called “Bounded-Scope Determinism” (BSD). The pipelines for producing accurate high-level NLP embodiments are called “Model Correction Interfaces” (MCIs). MCIs can be built using BSD low-level processes or they can be built using low-level processes known elsewhere in the art. When using non-BSD processes, accuracy is still profoundly increased. However, MCI embodiments that use BSD processes achieve 100% accuracy on high-level NLP tasks. For example, MCIs that use BSD lower-level NLP processes achieve 100% accurate Summarization, 100% accurate Question/Answering, 100% accurate Exposition, and more.

### CROSS-REFERENCE TO RELATED APPLICATIONS

This application is a nonprovisional application of and claims priority from: U.S. provisional patent application Ser. No. 63/761,053 filed on Feb. 20, 2025; U.S. provisional patent application Ser. No. 63/750,084 filed on Jan. 27, 2025; U.S. provisional patent application Ser. No. 63/716,119 filed on Nov. 4, 2024; U.S. provisional patent application Ser. No. 63/668,678 filed on Jul. 8, 2024; and U.S. provisional patent application Ser. No. 63/566,107 filed on Mar. 15, 2024. The foregoing applications are incorporated in their entirety herein by reference.

### FIELD OF THE INVENTION

The invention relates to neural networks. More particularly, the invention relates to systems and methods for creating and training neural networks that accurately perform Natural Language Processing (NLP).

### BACKGROUND

Natural Language Processing (NLP) is a branch of artificial intelligence (AI) and computer science that focuses on enabling computers to understand, interpret, generate, and respond to human language. NLP combines computer science, and machine learning to bridge the gap between human communication and machine understanding. The technical field of NLP includes the development of machine learning models including Large Language Models and it includes fine tuning such models for specific NLP tasks.

The processes and tasks addressed by the technological field of NLP are well-known in the art. Examples of low-level NLP processes include Sentence Splitting, Coreference Resolution, Named-Entity Recognition, Entity Disambiguation, and Parts of Speech Tagging. Examples of high-level NLP processes include Summarization, Question/Answer, Exposition, and language-based Reasoning.

To date, the industry has failed to produce 100% accurate (or even near 100% accurate) low-level NLP processes-despite decades of time from numerous experts in the field-despite literally billions of dollars spent in pursuit of solving this intractable problem.

Consider the pursuit of accurate Sentence Splitting and Rephrasing (SPRP) as a perfect case in point. SYSTRAN machine translation began in 1968, and it included the NLP process of Sentence Splitting and Rephrasing (SPRP). It attempts to accurately split complex sentences into simpler ones to make the translation easier for the machine to perform.

The quest for accurate Sentence Splitting has since gone from rule-based approaches (1960s-1970s), to statistical approaches (1980s-1990s), to machine learning (2000s -2010s), to deep learning and neural networks (2010s-present). Yet, state-of-the-art Sentence Splitting continues to suffer from unacceptable error rates despite 55 years of significant effort and resources.

Today, the state-of-the-art (SOTA) for SPRP currently has an error rate of approximately 20% for narrative text. The error rate is higher for more complex text (such as that found in the legal, financial, and medical fields). The current SOTA for Coreference Resolution has a 16.4% error rate.

Sentence Splitting, Coreference Resolution, and Named-Entity Recognition are considered low-level processes as they can be used as subprocesses in the higher-level NLP processes such as Summarization, Question/Answer, Exposition and Reasoning. However, given the high error rates of the low-level processes, the industry has shifted to attempting to use Large Language Models (LLMs) such as OpenAI's ChatGPT for high-level NLP processes instead.

However, the real-world error rates of LLMs when performing high-level NLP processes are in the deep double digits. There is a profound difference between real-world performance versus overly simplistic benchmarks. Consider the Vectara benchmark for Summarization. OpenAI's GPT-4 had a purported 3% error rate. However, in the real world, GPT-4 makes mistakes in almost half of its summarizations. For example, researchers found “GPT-4 still makes mistakes on 46% of the summaries on average across attributes.” (https://direct.mit.edu/tacl/article/doi/10.1162/tacl_a_00702/124837/Reading-Subtext-Evaluating-Large-Language-Models, last visited Jan. 31, 2025).

The difference between the purported 3% error rate versus the 46% error rate is due to the length of the articles being summarized. The Vectara dataset consists of extremely tiny documents. Some “documents” are as short as nine words. As an example, here is the entirety of one such “document”: “Winter's Tale is a 1983 novel by Mark Helprin.” Here is another nine-word “document” in the dataset: “Down with Love is a 2003 romantic comedy film.” In stark contrast, the study referenced above examined GPT-4's accuracy on lengthy articles-producing a measurement more reflective of real-world production.

Likewise, Vectara reported a 3.5% error rate for OpenAI's GPT-3.5. However, GPT-3.5's error rate is actually 69% when summarizing legal texts. (https://arxiv.org/html/2401.01301v1, last accessed Jan. 31, 2025).

Thus, the real-world error rates for GPT-4 and GPT-3.5 when used for summarization are as high as 46% and 69% respectively, depending on the type of text being summarized. Meanwhile, engineers have been pursuing accurate, automated summarization for decades. (For example, see the 1958 paper entitled “The automatic creation of literature abstracts” by Hans Peter Luhn.) Apple recently ceased providing summaries of new stories due to its inability to find a way to accurately produce such summaries. Hence, there remains a long-felt need for creating an accurate system and method for the automated NLP process of summarization.

In summary, after 55 years of dedicated pursuit by leading engineers, and after literally billions of dollars invested in LLMs, there remains a long-felt need for a system and method of accurate NLP for both low-level and high-level processes.

A need exists for systems and methods for creating an accurate system and method for an automated NLP process of summarization.

Another need exists for systems and methods for solving the technological NLP problem of providing accurate, automated question and answering (Q/A).

Yet another need exists for systems and methods for accurate NLP for both low-level and high-level processes.

### SUMMARY

The invention relates to systems and methods of accurate Natural Language Processing (NLP) for high-level NLP processes using novel pipelines of low-level NLP processes, including methods for creating 100% accurate embodiments of the low-level NLP processes. These 100% accurate Low-Level processes can be pipelined to produce 100% accurate High-Level processes. This novel method for creating 100% accurate low-level NLP embodiments is referred to herein as “Bounded-Scope Determinism” (BSD). The novel pipelines for producing accurate high-level NLP embodiments are referred to herein as “Model Correction Interfaces” (MCIs). MCIs can be built using BSD low-level processes or they can be built using low-level processes known elsewhere in the art. When using non-BSD processes, accuracy is still profoundly increased. However, MCI embodiments that use BSD processes achieve 100% accuracy on high-level NLP tasks. For example, MCIs that use BSD lower-level NLP processes achieve 100% accurate Summarization, 100% accurate Question/Answering, 100% accurate Exposition, and more. Essentially, BSD and MCI form the missing building blocks for computerized processing of natural language, thereby resulting in accuracy breakthroughs on a multitude of NLP processes all at once.

The systems and methods described herein provide an advantage in summarization by providing an accurate, automated NLP process of summarization. These systems and methods also provide another advantage in solving a technological NLP problem by providing accurate, automated question and answering (Q/A). They also provide yet another advantage by providing accurate NLP for both low-level and high-level processes.

Accordingly, the invention features a bounded scope deterministic system for training a neural network. The system includes a computer and an associated memory, a neural network having at least one trainable parameter, a training parameter adjustment process for adjusting the at least one trainable parameter, at least one electronically stored training input, at least one electronically stored bounded-scope deterministic (“BSD”) target output, and a loss function for computing a cost that measures a deviation between each training output the at least one BSD target output. Each BSD target output is a deterministic transformation of the corresponding at least one electronically stored training input. The neural network transforms each training input of the at least one electronically stored training input based on the at least one trainable parameter to produce at least one training output. If the cost is below a threshold, training of the neural network stops. If the cost is not below the threshold, (i) the training parameter adjustment process adjusts the at least one trainable parameter to create an adjusted trainable parameter, (ii) the neural network reprocesses the at least one training input using the adjusted trainable parameter to produce at least one new training output, (iii) the loss function again computes the cost based on a deviation between each new training output and the at least one BSD target output, (iv) training stops if the cost is below the threshold, and (v) and if the cost is not below the threshold, another iteration of training is required, wherein the foregoing processes (i) through (iv) are repeated until the cost is below the threshold.

In another aspect, the invention can feature the neural network's size is large enough to achieve zero or near-zero cost during training.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions, will control.

### BRIEF DESCRIPTION OF THE DRAWINGS

FIG. 1 is a schematic diagram of one embodiment of hardware for a BSD NLP server (including a neural network server).

FIG. 2 is a flow diagram of one embodiment of a BSD NLP Network.

FIG. 3 is a table providing examples of training inputs and training outputs for creating a BSD NLP Network for Sentence Simplification.

FIG. 4 is a flow diagram of one embodiment of a system for 100% accurate BSD NLP transformation of complex documents.

FIG. 5 is a flow diagram of one embodiment of an FF Pipeline.

FIG. 6 is a flow diagram of one embodiment of a Relative Date Conversion Process.

FIG. 7 is a chart that compares the 18.4% error rate for the state-of-the-art method of sentence splitting to the 0% error rate for a real-world BSD Sentence Splitting neural network of the present invention.

FIG. 8 is a chart that shows the real-world results of a system and method of the present invention built upon FFs, which eliminated 100% of the hallucinations in the RAGTruth Corpus for GPT-4 and GPT-3.5 Turbo for both Evident and Subtle Conflicts.

FIG. 9 is a chart that compares the hallucination rate of GPT-4 (46%) versus a real-world BSD Summarization neural network (0%) of the present invention on text of similar length.

### DETAILED DESCRIPTION

Embodiments combining some of the inventive steps are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities, measurements, parameters, values, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

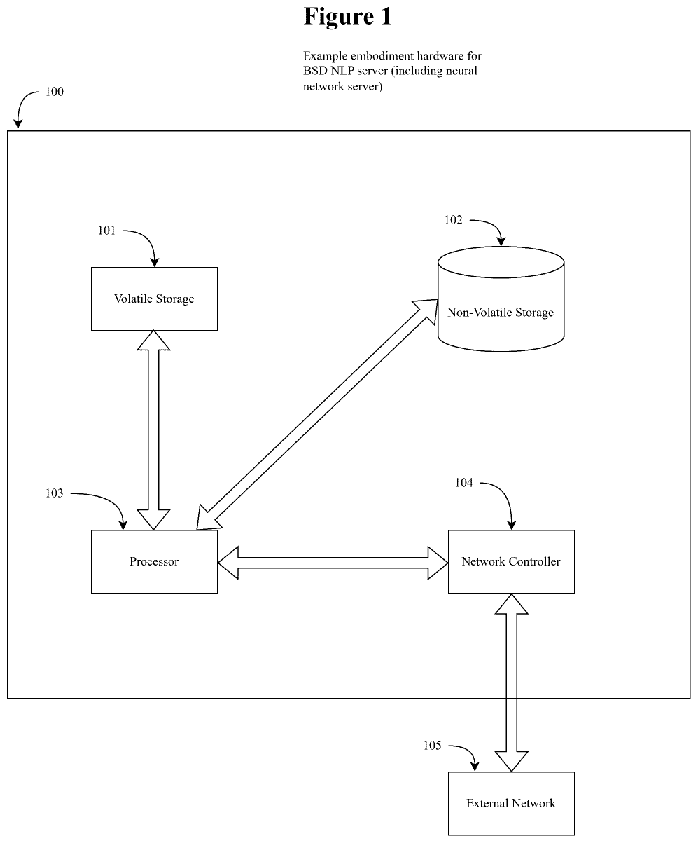

The invention provides systems and methods of accurate Natural Language Processing (NLP) for high-level NLP processes using novel pipelines of low-level NLP processes, including methods for creating 100% accurate embodiments of the low-level NLP processes, thereby resulting in 100% accurate implementations of the pipelined high-level NLP processes. This novel method for creating 100% accurate low-level NLP embodiments is referred to herein as “Bounded-Scope Determinism.” The novel pipelines for producing accurate high-level NLP embodiments are referred to herein as “Model Correction Interfaces” (MCIs). Various aspects of the systems and methods are shown in FIGS. 1-6.

The systems and methods described herein can be installed and performed on one or more computing devices. Each such computing device can include one or more displays for viewing content or other visual displays (e.g., graphical user interfaces, etc.) of the system and one or more user input devices for operating one or more controls or other parts of the system. In some exemplary embodiments, processes of the systems described herein are installed on and operated by one or more servers having a communicative connection to one or more computing devices via which a user or users access and use the system.

The computing device is a computer (e.g., a desktop computer or a lap top computer), a tablet computer, a cellular telephone (e.g., a smart phone), a personal digital assistant, a television (e.g., a smart television), a gaming device, a router, a server, a printer, a camera, or any other computing device having a processor and an associated memory and may also be capable of communicatively connecting to a communications network.

For convenience, in some instances, the communications network is referred to herein as the Internet; however, in some embodiments, the communications network can be a different type of network, e.g., a local area network (LAN), a wide area network (WAN), or a virtual private network (VPN). The communications network can include one or more of the types of networks identified above, including multiple instances of a type of network and combinations of one or more types of networks. The communications network can be wired, wireless, or a combination of wired and wireless networks.

In embodiments containing a display, the display is a computer monitor or display screen. The display is communicatively connected to the computing device and can be an integral part of the computing device or a separate device that includes a wired connection or a wireless connection to the computing device.

In embodiments containing a user input device, the user input device can be a mouse, a trackball, a touch pad, or a touch screen. The system's display can be a touch screen. In other embodiments, the system can include both a display and a separate touch screen device. In some embodiments, the user input device is a microphone communicatively connected to a computing device that includes software for receiving a voice command to select a link shown on the display. In one embodiment, the user input device used to select the link is a brain-computer interface. In other embodiments, the user input device can be a pointing device, keyboard, joystick, gamepad, jog, dial, camera, button, switch, controller, or voice command device. The user input device is communicatively connected to the computing device and can be an integral part of the computing device or a separate device that includes a wired connection or a wireless connection to the computing device.

In embodiments containing a server, the server can be remote from the location of the computing device or in the same location as the computing device. The server may include some or all of the processes described herein installed thereon, which are then accessible to one or more computing devices via a communicative connection provided by the communications network between the server and the one or more computing devices.

The term “content,” as used herein, includes documents (e.g., Word, Excel spreadsheet, or PDF documents), videos, audio files and recordings, photographs, images, web pages, emails, text messages (e.g., SMS and MMS messages), chat messages, instant messages, and social media application and website posts and messages.

### 100% Accurate NLP

This disclosure presents three systems and methods that can be used to achieve 100% accuracy on both Low-Level NLP Tasks and High-Level NLP Tasks.

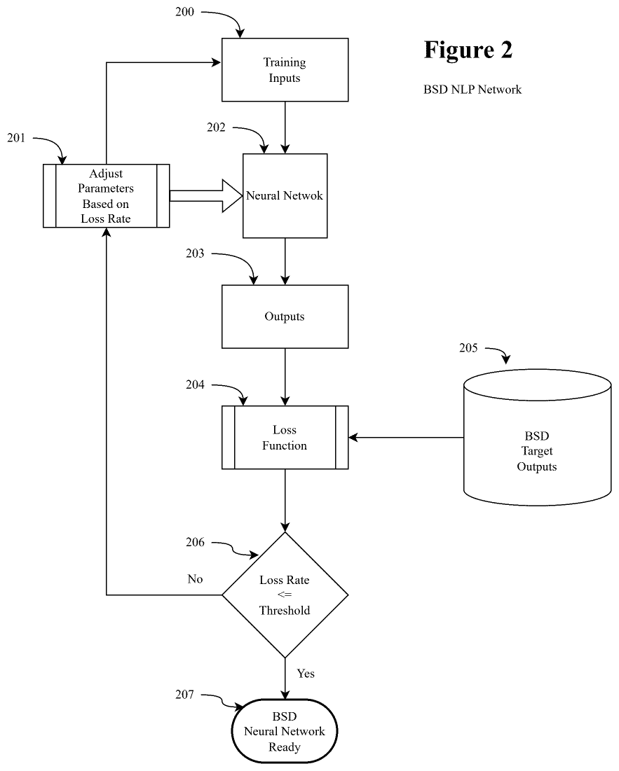

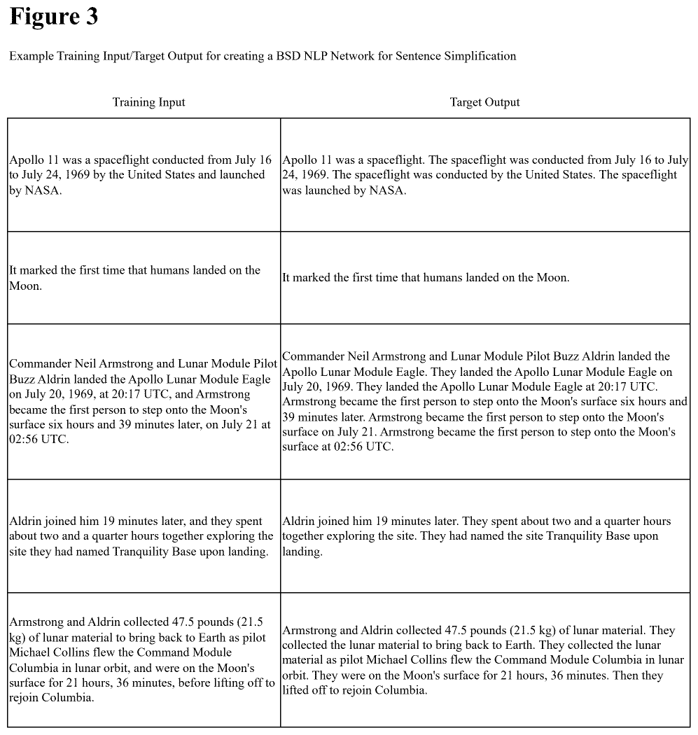

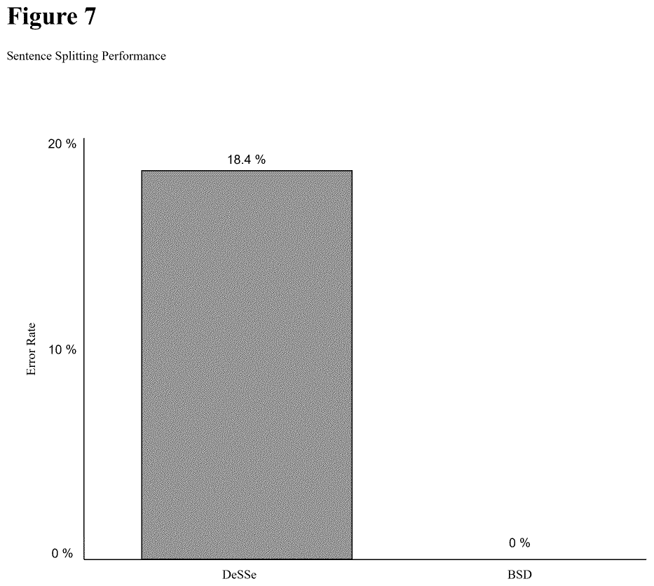

First, this disclosure presents a system and method for training BSD NLP Networks (see FIGS. 1-2). BSD NLP is a method of training neural networks to perform NLP tasks with 100% accuracy. For example, the state-of-the-art (SOTA) sentence splitting method has an 18.4% error rate. The SOTA neural network was trained on DeSSE—a dataset containing 13,199 entries. In stark contrast, a 5-entry BSD NLP set (see FIG. 3) used in few-shot prompting resulted in a 0% error rate in internal testing (see FIG. 7). The accuracy of the 5-entry set was tested by splitting 2,500 sentences in BBC news articles. In comparison, the developers of the SOTA method tested only 790 sentences. In other words, 5-entry BSD NLP maintained 100% accuracy in more stringent testing.

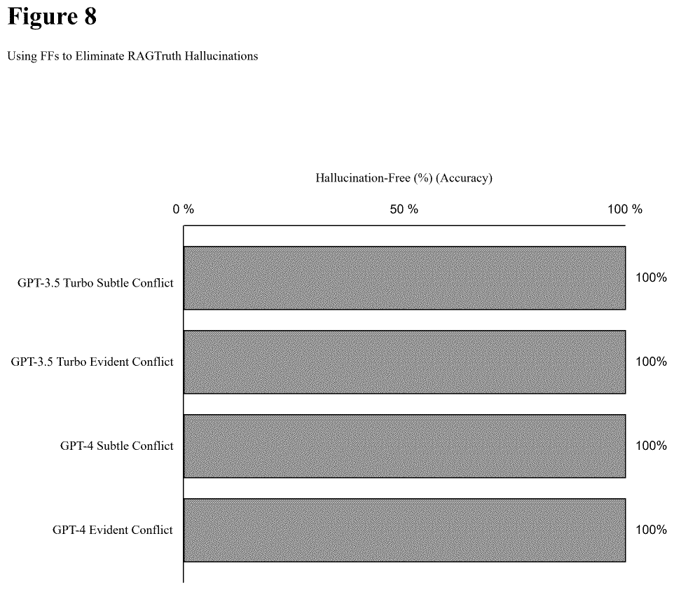

Second, this disclosure shows how to use BSD NLP Networks to create Formatted Facts (FFs). FFs are simple, self-contained facts derived from the input text. FFs can be used to significantly improve the accuracy of virtually every NLP task. For example, a system built on top of FFs eliminated 100% of the hallucinations in the RAGTruth Corpus for GPT-4 and GPT-3.5 Turbo for both Evident and Subtle Conflicts (see FIG. 8). For additional details, see “100% Hallucination Elimination Using Acurai.” (https://arxiv.org/html/2412.05223v1)

Finally, this disclosure presents a system and method called Formatted-Facts Model Correction Interface (FF MCI). The FF MCI can be wrapped around virtually any fact-based NLP task to ensure 100% accurate responses.

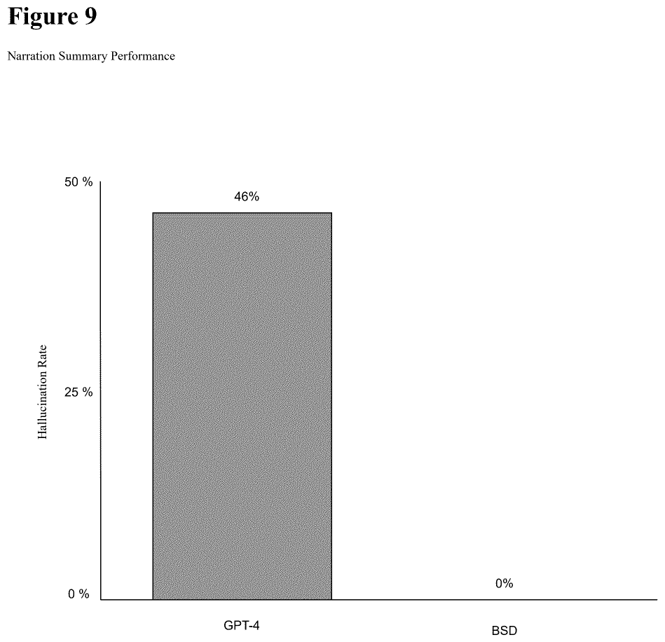

FF MCI was internally tested on summarizing BBC news articles. Apple News recently discontinued providing BBC news summaries due to unacceptable hallucinations in Apple's technology. The tested FF MCI embodiment of the systems and methods of the present invention had zero hallucinations when summarizing 500 BBC news articles. BBC News articles are of similar length to documents used by other researchers when assessing GPT-4's summarization capabilities. FIG. 9 compares the hallucination rate of the real-world BSD Summarization neural network (0%) of the present invention to the hallucination rate of GPT-4 (46%) when summarizing narration of similar length.

Thus, the systems and methods disclosed herein achieved 100% accuracy on Low-Level NLP tasks (such as sentence splitting) and High-Level NLP tasks (such as summarization), and they can also be used as the foundational building blocks in larger systems for 100% accuracy in LLMs and chatbots.

Bounded-Scope Deterministic NLP (BSD NLP) vs. SOTA Training Methods

BSD NLP is a system and method for training a neural network to perform an NLP task with 100% accuracy.

BSD NLP is perhaps best explained by way of contrast. Therefore, this section contrasts BSD NLP Network training of the present invention against the way NLP training is done in the current art. This section discloses the core criteria and steps of BSD NLP by comparing it to SOTA methods for training neural networks to perform sentence splitting.

Sentence splitting is a fundamentally important NLP task. After all, sentence splitting is a fact extraction process. Neural networks trained using BSD NLP achieve 100% accurate sentence splitting (hence 100% accurate fact extraction).

The SOTA datasets used to train neural networks for Sentence Splitting and Rephrasing are: DeSSE, BiSect, WikiSplit, and Websplit. DeSSE has 13,199 entries. BiSect has 928,440 entries. WebSplit has 1,331,515 entries. The 5-entry BSD set (see FIG. 3) achieved 100% accuracy whereas neural networks trained on over one million entries achieved approximately 80% accuracy or less. Just 5 BSD NLP entries significantly outperformed neural networks trained on over one million other types of entries. That is because each BSD NLP entry is structured in a very specific manner that communicates to the neural network precisely what it needs to learn to do. This has been the missing key to 100% accurate NLP neural networks.

In short, the industry has been training language-based neural networks using stochastic, non-deterministic methods. On one hand, the industry may seem to be pursuing the correct path. After all, there are many grammatically correct ways to split a larger sentence. Therefore, it can even seem incorrect for a neural network's loss function to assign a penalty cost to a grammatically correct split during training.

Yet, as will made clear shortly, BSD NLP intentionally causes the loss function to assign a cost to grammatically correct sentence splits. In fact, counterintuitively, BSD NLP often requires the loss function to assign a cost to the vast majority of grammatically correct splits.

Compare training neural networks on WebSplit versus training neural networks using BSD NLP. The WebSplit dataset provides many grammatically correct outputs for each input. Consider the following sentence: “Auburn is part of Lee County in Alabama which is situated within the state of Alabama in the United States where one of the ethnic groups in the United States are the African Americans.” The WebSplit dataset contains 64 alternative splits for this sentence alone. In other words, there are 64 entries in the data set where the input is this same sentence. However, each of the 64 outputs provides one grammatically correct alternative for splitting that sentence. Hence, for this one sentence, there are 64 input=>output pairs, where each output gives an alternative correct split.

In stark contrast, a preferred BSD NLP embodiment requires that there is only one unique output for each unique input. Assuming there are only 64 ways to split the above sentence, this means that 63 out of 64 splits will be deemed an error during training, even though they are grammatically correct. In terms of this sentence, that means 98% of the grammatically correct splits are counted as being errors. If there are more than 64 grammatically correct splits, then more than 98% of the grammatically correct hits will be considered to be an error when training a neural network using preferred embodiments of BSD NLP.

BSD NLP stands for Bounded-Scope Deterministic NLP. The NLP part of the name signifies that the input text must contain at least one human-language sentence. The BSD part is built on two aspects: bounded in scope, and deterministic. Bounded scope refers to the number of required transformations being small enough to be learned (e.g., small enough to achieve a zero cost value from the loss function during training). As for the determinism aspect of BSD, there are seven criteria:
1) There is only one unique output per unique input.
2) The unique output must be deterministically derived from the input text.
3) The selection of transformations that produce the output must be deterministically derived from the input.
5) Where the resulting output has multiple values, such that the order of the values can be changed without information loss, the order of the values must be sorted in a deterministic manner. Preferred embodiments will use first positional occurrence sorting.
4) The selected transformations must be uniformly applied to all outputs.
6) Where the deterministic selection of transformations can be null, there must be at least one input=>output pair in which the inputs and corresponding outputs are identical in every respect. The inclusion of additional such pairs will reduce both the size of the neural network required and reduce the training time and cost.
7) Where selection counter examples exist, they must be provided in the input, and the corresponding outputs must be identical to the input.

Training neural networks on WebSplit does not involve any of the above steps. Training neural networks on the rest of the SOTA datasets does not involve implementing criteria 2-6. Yet, as is explained below, steps 2, 3, and 4 are core criteria; and steps 5, 6, and 7 are conditional core criteria. Hence, SOTA training lacks all of the core criteria (at least in terms of SOTA sentence splitting).

The following explains how to train a neural network to accurately split larger sentences into smaller ones. Consider a simple transformation (Transformation X): Remove the word ‘and’; if the next word is a noun, then add the same punctuation used at the end and capitalize the next word; if the next word is a verb, add the same punctuation used at the end, add the noun subject of the prior statement, capitalize the added noun subject.

On the surface, splitting a sentence on the word ‘and’ appears trivial. However, even Transformation X is insufficient to qualify as being deterministic. What if the noun subject is a nested noun phrase? What gets added to the beginning of the new split: the entire nested noun phrase, the complex noun phrase, the noun phrase, or the root noun phrase? Each embodiment must implement a deterministic choice, and apply that choice consistently.

A preferred embodiment would implement the entire noun phrase length (including nesting) to ensure the preservation of meaning. This deterministic criterion means that there is only one correct choice for what gets added to the beginning of the new split. One correct choice, and only one. Everything else is an error when computing the loss function-regardless of whether it is grammatically correct or not. Adding this step to Transformation X results in Deterministic Transformation X.

Even though Deterministic Transformation X is only a very simple example of criteria 2 and 3, notice already that none of the SOTA training methods do either of these. In other words, even before introducing additional transformations, BSD NLP is already different from SOTA sentence splitting.

Consider step #2: deterministically derive the output from the input. WikiSplit annotators had a free hand in choosing where to split. They also freely added words of their own choosing. Thus, step #2 was not performed in the creation of the WikiSplit dataset. The other training datasets also gave the annotators a free hand on where to split, and the annotators also added words of their own choosing. Thus, none of them implemented step #2.

This is literally the opposite of Deterministic Transformation X. Notice how Deterministic Transformation X dictates the precise words that must be added (e.g., the entire noun phrase length of the subject noun phrase (including nesting)). That is the mirror opposite of allowing annotators to choose. In BSD NLP, the D means there are no choices during training. If the deterministic transformation has two or more viable alternatives, then it is not a deterministic transformation in the first place.

Consider step #3: deterministically choose the selected transformation based on the input. Once again, the creation of the SOTA datasets did not include this step. WikiSplit and BiSect always split the input into two sentences. This means that the annotator subjectively chooses whether to split a particular sentence on “and,” or “but,” or “wherein,” etc. There is no deterministic selection of transformation based on the input.

However, Deterministic Transformation X always results in one split for each ‘and’ that serves as a coordinating conjunction. If there is one such ‘and,’ then there is one split. If there are two such ‘ands,’ then there are two splits. And so forth.

The mere fact that WikiSplit and BiSect force the input into two splits further demonstrates that step #3 was not used (in addition to not using step #2). Likewise, the annotators of DeSSE were instructed to pick one to four splits of their own choosing from a list of recommended splits. Hence, DeSSE also did not implement step 2 or step 3.

Just as step #2 is the mirror opposite of SOTA training, so too is step #3 another step that is mirror opposite of SOTA training.

Now consider step #4: The selected transformations must be uniformly applied to all outputs. As stated above, in regards to Deterministic Transformation X, the transformation must be applied every time the word ‘and’ serves as a coordinating conjunction. Also as stated above, none of the SOTA training sets uniformly applied even one transformation across the entire training set, thereby not implementing this step as well.

SOTA NLP training is based on the idea that neural networks learn intelligence, with the idea being that if the neural network is given a variety of correct ways to split a sentence, then it can learn to choose the best way for any given new sentence.

BSD NLP is based on the exact opposite premise, which is why the steps are literally the mirror opposite of SOTA training methods. BSD NLP is based on the premise that every choice introduced in the outputs adds a degree of error not a degree of intelligence. The fundamental training premises could not be more different.

Now consider step #6: Where the deterministic selection of transformations can be null, there must be input=>output pairs in which the inputs and corresponding outputs are identical in every respect.

Not all sentences need to be split. For example, where splitting is solely based on Deterministic Transformation X, then sentences that do not have the word ‘and’ should not be split. Therefore, the training data needs to contain examples of when not to split. That is the meaning of step #6 as it relates to sentence splitting.

Yet, notice that none of the SOTA training sets contain even one instance where the input remains the same. Unlike SOTA, BSD NLP says that the neural networks do not learn intelligence, they learn to perform the path of least resistance instead. Thus, the neural network needs to be told when to do nothing so that doing nothing is included in its learned path of least resistance.

Notice that Deterministic Transformation X makes an evaluation on the word ‘and.’ It evaluates whether the word is serving as a coordinating conjunction.

Consider the following sentence: “Tom and Mary walked into the house and sat down.” Only the second ‘and’ serves as a coordinating conjunction. The first ‘and’ does not.

Step #7 means that there should be counter example inputs for every evaluation made by the deterministic selectors.

In terms of transformation X, this simply means there needs to be inputs that include the word ‘and’ where ‘and’ is not being used as coordinating conjunction; and therefore, there is no split. Hence, the output equals the input.

Again, since all the datasets solely contain splits, they also do not implement step #7 cither.

In short, there are two types of non-splits (i.e. two types of output=input): inputs where no transformation is even selected, and inputs where the selected transformation declines to perform the transformation due to one or more deterministic evaluations. The criteria in steps #6 and #7 define the types of inputs to include to produce a corresponding output that signifies that a transformation did not take place. Hence, an alternative output to accomplish the same thing can be to return a predefined value (such as “[BLANK]”) as the target output, as this accomplishes the criteria of signifying when a transformation did not take place.

Once the steps are understood, they can easily be applied to training a neural network on virtually any NLP task, including sentence splitting. And because the training is based on the inverse of SOTA methods, it produces profoundly different results. In fact, where all the steps are followed in producing the input/output pairs, the resulting BSD NLP Network can achieve 100% accuracy-a significant leap in performance over current systems and methods in the technical field of NLP.

### Target BSD Output

A preferred BSD NLP embodiment will employ all seven criteria/steps. However, steps 2-4 are core BSD NLP criteria. Steps 5-7 are conditional core BSD NLP criteria (i.e., they are core components in NLP tasks that meet the stated condition of the criteria). Consider an embodiment in which a transformation selection can be null. For such an embodiment, step #6 is a core component because of this condition.

A preferred embodiment will implement all core criteria, and it will implement all conditional core components that match the conditions of the embodiment. Such a preferred embodiment thereby produces Perfect BSD Target Outputs from the corresponding training inputs.

However, an embodiment that implements at least one core criteria and/or implements one conditional core criteria falls within the spirit and scope of this disclosure. While the combination of core criteria ensures 100% accuracy, some NLP tasks may only require implementing some of the core criteria to significantly improve accuracy-even to the point of 100% accuracy. Moreover, BSD criteria are so transformative that even applying them to part of a dataset can significantly improve performance. Therefore, doing so falls within the spirit and scope of this disclosure.

For example, the five entries in FIG. 3 implement core criteria 1 through 6. Yet, in regards to Sentence Splitting, the fulfillment of criteria 1-6 allowed five examples to achieve 100% accuracy on 2,500 sentences in BBC news articles (see FIG. 7).

Herein, BSD Target Output refers to implementing at least one core criteria for transforming inputs containing human-language sentences into deterministically transformed NLP output. Where all core criteria are applied, as well as all conditional core criteria that are applicable to the conditions of the embodiment, the NLP deterministic transformation of such sentence-containing training input shall be referred to as Perfect BSD Target Output.

### Step #5: BSD NLP Output Sorting

None of the sentence splitting datasets implement step #5 because it does not apply to splitting a complex sentence into five sentences. The task itself results in ordered output—in order to preserve the meaning of pronouns.

However, some NLP tasks can result in the output containing multiple values whose values can be presented in at least one different order while preserving all information. Such NLP tasks meet the condition of step #5, and therefore, such a preferred embodiment would included step #5 to ensure 100% accuracy.

Moreover, such preferred embodiments will use first positional occurrence sorting. This simply means sorting the order of the values based on the order in which they first appear in the input.

For complex NLP tasks based on multiple steps, a separate first positional occurrence sorting can be applied at each step. This is explained immediately below.

Consider the task of extracting facts about people in a text. Here, the task may involve two levels (i.e., two steps): identify all people, and identify all facts in the input about each person.

When there are multiple levels of an NLP task, a preferred BSD embodiment can use first positional occurrence sorting for each level. Consider a series of self-contained statements. Some statements are about Alice and others are about Bob. Alice is mentioned first. However, some of the statements about Alice occur after Bob is mentioned.

One deterministic method is to use a one-pass first positional occurrence sorting across the dataset. Thus, the Alice and Bob extractions will occur left to right in a single pass. Thus, some of the Alice statements will indeed be included in the target output after some Bob extracted statements.

However, a multi-level first positional occurrence would allow the target output to be deterministically organized as: {name}: \nFact_1\nFact_2\n . . . . In other words, the facts about each person are grouped together immediately after the person's name.

Since this is a two-level task, a two-pass first positional occurrence sorting can be used. The sort order of the names is determined by the first pass. The order of the extracted facts is determined by the second pass. In this way, all of the statements regarding Alice and Bob are grouped together under their respective names while still preserving the requirement of deterministic first positional occurrence sorting.

As long as each name is selected in the order in which they appear in the text; and as long as the facts regarding each name are listed in the order they appear in the text; and as long as the extraction of the facts is done in a deterministic manner (e.g., preserving the facts verbatim), the BSD neural network can now extract grouped facts about people with 100% accuracy.

BSD Neural Network Training revolutionizes the use of neural networks for NLP and the NLP subfield of AI. It consistently results in 100% accuracy, even on complex language tasks.

At first blush, the preference of first positional occurrence sorting may seem insignificant. However, modern language models are built on token-based transformers. These transformers do not have any inherent awareness of the individual characters in the words they are processing. Hence, using alphabetical sorting would require increasing the size of the model many magnitudes (if such can even overcome the limitation). However, token-based transformers inherently possess positional awareness. By basing the sorting on position, the sorting is based on the inherent capabilities of the architecture, thereby allowing smaller models to achieve 100% accuracy.

### Example Embodiment of BSD Neural Network

BSD Target Output refers to a target output that is deterministically derived from a training input in accordance with the above criteria. Any neural network trained on at least one BSD Target Output falls within the spirit and scope of this disclosure.

FIG. 1 and FIG. 2 illustrate an example embodiment of a BSD Neural Network. FIG. 1 depicts example hardware. FIG. 2 depicts an example process flow for training a neural network.

FIG. 1 shows a BSD neural network 100 (e.g., a NLP server) that includes a volatile storage 101 and a non-volatile storage 102 communicatively connected to a processor 103. The processor 103 is communicatively connected to a network controller 104 that communicatively connects the BSD neural network 100 to an external network 105.

The Training Inputs 200 contain at least one human language component. Training inputs are converted into numerical sequences (usually by tokenization) such as converting text to numerical tiktokens (as OpenAI does for its GPT models). Another popular method is to use SentencePiece to convert text into numerical sequences (as the Llama family of LLMs does). Any method for converting text into numerical sequences falls within the spirit and scope of this step. The numerical sequences are the actual input into the electronic Neural Network 202. Example neural networks include RNN, CNN, and transformer-based (such as GPT). Any supervised neural network can be used, provided that it supports training on text inputs and outputs. The training method depicted in FIG. 2 can be applied to both seq2seq and autoregressive models. Those ordinarily skilled in the art know how to set up the supervised training of seq2seq, autoregressive, and other supervised neural networks. They also know how to choose the model architecture for the given NLP task at hand.

In seq2seq, each input 200 would be sent to the Neural Network. In autoregressive training, a sliding window would likely be used where each numerical token from the target output 205 is appended token-by-token to the input 200 to form another input; whereas the next token in the target output is the desired result in the given iteration. Those ordinarily skilled in the art know how to implement both seq2seq and autoregressive networks without further explanation.

For each iteration (i.e., epoch), the Loss Function 204 computes the difference between the output 203 of the Neural Network 202 and the corresponding BSD Target Output 205. It is this step where a Loss Function 204 uses BSD Target Outputs to compute the “loss” (or “cost”). It is this step where over 98% of grammatically correct sentence splits can be assigned a penalty cost during BSD NLP training on sentence splitting.

Embodiments can use Cross-Entropy Loss (Log Loss), KL Divergence, Reinforcement Learning, Contrastive Loss or any other loss methods. Any loss method that computes cost relative to the output of the Neural Network and at least one BSD Target Output is a novel innovation, and therefore, falls within the spirit and scope of this disclosure (where the BSD Target Output is a bounded-scope, deterministic transformation of the correlating Training Input).

Herein, for simplicity, Loss Function shall refer to loss functions known in the art, as well other measurements such as those used in reinforcement learning. While loss functions would typically be used for computing token-by-token differences in NLP neural networks (such as Large Language Models), Reward Signals could be used on a whole sequence basis and are therefore simply referred to as Loss Function herein. Thus, the term Loss Function is not meant to limit the seq2seq or token-by-token loss calculations chosen for any given embodiment. The limitation is that at least one BSD Target Output be used when computing such. This is the step that can transform the current art from 80% accuracy to literally 100% accuracy. This step can be applied to virtually any Low-Level NLP Neural Network to profoundly increase accuracy. Where a zero loss is eventually reached, the accuracy can literally be 100%.

If the loss during the iteration is less than or equal to the chosen threshold 206 then the training is done 207. The current state of the trained parameters allows for the Neural Network to accomplish its task with optimal accuracy. The state of the trained parameters can be stored in RAM, on disk, in the cloud, or via any other method (thereby allowing the model and its optimal parameters to be replicated on various devices). Moreover, the model with the optimized parameters can be saved as a whole to permanent storage.

Once the threshold has been reached, any input can now be sent to the Neural Network, and the output will be accurate (up to 100% accurate where a zero loss has been reached).

If the threshold has not been reached 206, then the trainable parameters are adjusted relative to the loss 201. Methods for adjusting the parameters (such as weights and biases) are well-known in the art (such as using back propagation and gradient descent with optimizers such as Adam and RMSProp). As previously stated, the innovative step of determining loss based on outputs that are bounded-scope, deterministic transformations of the input can profoundly improve the accuracy of a multitude of NLP Neural Networks. Alternatively, where the scope cannot be bounded, determining loss based on deterministic transformation of the input will profoundly improve accuracy (where deterministic transformation meets the novel criteria disclosed herein). Hence, such would still fall within the spirit and scope of this disclosure.

### BSD NLP for 100% Accurate Sentence Splitting

BSD revolutionizes the technological field of Natural Language Processing (NLP) by yielding 100% accuracy for low-level NLP tasks. Herein, BSD shall be used as shorthand for BSD NLP. For example, the BSD system and method produces Sentence Splitting embodiments that split sentences with 100% accuracy. See FIG. 2 and FIG. 3 for an example BSD Sentence Splitting embodiment. FIG. 3 provides an example embodiment of Training Input and corresponding BSD Target Output. The training data is typically provided to LLMs in JSONL files stored in volatile storage. However, there are many methods known in the art for providing the electronic training data to the neural network. Provided that the input contains human language, and provided that the target output is a deterministic transformation of the input (according to the criteria disclosed herein) such electronically provided training data falls within the spirit and scope of this disclosure. Electronically storing training data in either volatile memory, non-volatile memory, or both falls within the spirit and scope of this disclosure.

It bears noting that such training data can alternatively be used in few shot prompting in addition to or in lieu of being used for fine tuning. In fact, a 5-shot prompt using the example training data resulted in 0 hallucinations when simplifying 2,500 sentences from BBC articles.

A simple sentence splitting embodiment could include splitting complex sentences based on coordinating clauses that start with the word “and” (or another coordinating conjunction such as “but,” “or,” “for,” “nor,” “yet,” or “so”). The transformation must also dictate under what deterministic conditions will words be added, and there must be a deterministic method for knowing precisely what words will be added (e.g., the entire subject noun phrase including nesting). In this situation, there is one objective transformation for converting each input into the target output, thereby satisfying the “determinism” aspect of BSD.

Given that the neural network is being used to process language, the network architecture could be a transformer-based model. However, since the bounded scope criteria is based on loss function, it can be a recurrent neural network (RNN), long short-term memory (LSTM), gated recurrent unit (GRU), convolutional neural network (CNN), and even a feed forward network. Moreover, it can include a future architecture, provided that such architecture includes a loss function and such loss function reaches a level below a given threshold; and where such architecture is trained using the aforementioned deterministic criteria.

Any trainable network or model containing learnable parameters that are adjusted at least in part by a loss function or other measurement of deviation between the neural network output and a provided target output, such that the provided target output is deterministically derived from the training input in accordance with the above, falls within the spirit and scope of this disclosure.

In regards to 100% accurate sentence splitting, consider the following input/output pairs:
Training Input: The cat sat on the chair and it was purring.
Target Output: The cat sat on the chair. It was purring.
Training Input: Tom drove home.
Target Output: Tom drove home.

The above is based on a single objective transformation of training input to target output. The sentences are split on the word ‘and’ where the word is being used as a coordinating clause, and where the word that follows the word ‘and’ is a noun phrase. Since sentence two does not have the word ‘and,’ no transformation is selected resulting in the target output being equal to the training input.

This exemplifies an alternative aspect of BSD. In BSD, the training set can include examples where the objective transformations result in the target output being identical to the training input. This greatly diminishes the size of the model needed, and greatly reduces the amount of training time required, to achieve zero or near-zero training loss. Therefore, achieving 100% accuracy with cheaper, smaller models.

Now, consider another simple BSD embodiment with multiple objective transformations. As a reminder, where multiple objective transformations exist, the selection of such transformation(s) must be deterministically derived from the input itself.

With this in mind, another embodiment could include splitting complex sentences using two objective transformations. The first objective transformation (OT) could be to split on coordinating clauses that begin with the word ‘and’ whenever the following word is not a verb (Deterministic Transformation Y). The second OT could be to split on coordinating clauses that begin with the word ‘but’ whenever the following word is not a verb (Deterministic Transformation Z). The multiple OTs would result in deterministically producing the following input/output training pairs:
Training Input 1: The cat was sitting on the chair and it was purring.
Target Output 1: The cat was sitting on the chair. It was purring.
Training Input 2: The dog wanted the bone but it was out of reach.
Target Output 2: The dog wanted the bone. It was out of reach.
Training Input 3: The dog was sitting on the chair and it wanted the bone but it was out of reach.
Target Output 3: The dog was sitting on the chair. It wanted the bone. It was out of reach.
Training Input 4: Harry met Sally.
Target Output 4: Harry met Sally.
Training Input 5: Tom and Mary drove home.
Target Output 5: Tom and Mary drove home.
Training Input 6: But, he chose to come over.
Target Output 6: But, he chose to come over.

While such an embodiment would require a larger neural network than the prior example, the number of learnable parameters would still be quite small compared to some of the most popular models in the art.

Notice also that the correct splitting may be one sentence (no splitting), two sentences, or even three sentences. Where objective transformations are applied, the number of output sentences can vary. In fact, splitting complex sentences can result in anywhere from one to a dozen (or even more) simpler sentences in certain embodiments.

Notice how the entries conform to the criteria:
Pair 1: Selecting and Implementing Deterministic Transformation Y
Pair 2: Selecting and Implementing Deterministic Transformation Z.
Pair 3: Selecting and Implementing Deterministic Transformation Y & Selecting and Implementing Deterministic Transformation Z.
Pair 4: Null Selection of Transformations (i.e., no transformations selected).
Pair 5: Selecting and Declining Deterministic Transformation Y.
Pair 6: Selecting and Declining Deterministic Transformation Z

Hence, Pair 5 is an example of step #6. Pairs 5 and 6 are examples of step #7. Deterministic Transformation Y makes a deterministic evaluation based on the word ‘and.’ The determination is whether to implement the transformation or decline to do so. Therefore, the neural network needs a training entry for each of these scenarios (e.g., Pair 1 and Pair 5). Likewise, Deterministic Transformation Z makes a similar deterministic evaluation on the word ‘but.’ Hence, the neural network needs an example of both scenarios (e.g., Pair 2 and Pair 6). Thus, the seven steps/criteria guide the creation of entries for various deterministic decisions (e.g., Select and Implement Y, Select and Decline Y, Select and Implement Z, Select and Decline Z, null Selection (i.e., no Selection)). It is in this way that the path of least resistance equals performing the desired task with 100% accuracy.

A more sophisticated sentence splitting machine can include a set of objective transformations based on both clauses and prepositions. It can even include rewriting words, provided that the rewriting is deterministic.

For example, when choosing to write noun phrases during sentence splitting, an objective transformation must choose whether to consistently use a noun phrase, a complete compound noun phrase, a complete nested noun phrase, etc. The same objective transformation is applied consistently throughout the training set. In stark contrast to existing systems and methodologies, BSD is founded on deterministic consistency.

Likewise, consistency may be applied in regards to person named entities. For example, the chosen objective transformation may use the full name, or the last name, or an abbreviation, etc., provided that such is applied consistently throughout the training set.

Consider the following complex sentence: “Tom Smith of Dallas and husband of Mary loves to barbecue and he enjoys drinking beer.”

If the objective transformation is based on noun phrase, there is only one correct split (and therefore, the correct split is objectively deterministic): Tom Smith of Dallas and husband of Mary loves to barbecue. Tom Smith enjoys drinking beer.

Any other split would be incorrect.

If the objective transformation is based on complex noun phrases, there is only one correct split: Tom Smith of Dallas and husband of Mary loves to barbecue. Tom Smith of Dallas enjoys drinking beer.

Any other split, including the prior example, would be incorrect.

If the objective transformation is based on nested noun phrases, there is only one correct split: Tom Smith of Dallas and husband of Mary loves to barbecue. Tom Smith of Dallas and husband of Mary enjoys drinking beer.

Any other split would be incorrect, including the prior two examples.

The bolded, italic terms illustrate how the objective application of a deterministic transformation provides the consistency that the neural network needs in order to fully master the task. While all three choices (and others) are linguistically correct, 100% accuracy comes from teaching the neural network one consistent objective. The current SOTA wrongly believes that neural networks will try to figure out the best alternative. This present invention is based on the correct understanding that neural networks do the opposite-they consistently look for the path of least resistance instead. Thus, BSD provides the path of least resistance to ensure the task is truly mastered.

This is the missing key over existing systems and methods. There are no 64 correct alternatives for a given input as is the case for neural networks trained on WebSplit. There are no variations of purportedly correct outputs caused by various annotators choosing different ways to split the sentences (e.g., one annotator uses noun phrases, another uses complex noun phrases, another sometimes uses nested noun phrases and other times leaves the pronoun alone, etc.). There is no starting with subjective human summaries. There is no starting with non-deterministic sentence graphs. This present invention is the literal opposite of SOTA NLP models that are based on the faulty premise that neural networks can learn to choose the best alternatives. For 100% accuracy, neural networks need to be trained on only one definitive, deterministic transformation for each potential input type. The rest of neural network training can proceed as usual. Meanwhile, the accuracy jumps double digits.

As stated earlier, the model's hallucination rate is proportional to the degree that the neural networks and other models deviate from BSD. The inverse is that the closer neural networks and models are to BSD, the greater their accuracy. Therefore, adjusting any neural network or model to be closer to an ideal BSD implementation falls within the spirit and scope of this disclosure.

For example, including at least one target output that is deterministically derived from a training input falls within the spirit and scope of this disclosure. After all, the accuracy of the model will increase with each added BSD Target Output.

There may be tasks that cannot be bounded. However, the accuracy of the model can be extremely improved by still adhering to the deterministic requirements of target outputs. Hence, BSD can be used to achieve optimal accuracy for virtually any fact-based NLP task.

In BSD, the neural network learns to select and apply the one correct objective transformation for the given input. Not choose between a variety. For example, in a BSD embodiment that includes five objective transformations, for any given input there is only one correct selection of transformation(s) and only one correct output after applying the correctly chosen transformation(s).

For example, where the objective transformations consistently include splitting on both ‘and’ and ‘but’ coordinating clauses, a sentence containing one ‘and’ coordinating clause and containing one ‘but’ coordinating clause must be split on both.

To not split on either is an error when computing the loss function. To split on only one of them is an error when computing the loss function. To create a hybrid transformation is an error when computing the loss function. The only way to achieve a zero loss is to consistently split on both throughout the training set. It is this very lack of variety that gives the neural network the guidance it needs to fully master the problem, and thereby produce 100% accurate output every single time.

It is within the realm of possibility that someone working on and with the existing systems and methods has recognized that consistently splitting on an ‘and’ coordinating clause could be learned by a neural network. Even if such exists, those ordinarily skilled in the art still have not developed a systematic method of applying multiple objective transformations to accurately split complex sentences into many smaller ones (such as splitting an extremely complex sentence into a dozen smaller ones with 100% accuracy) as documented by current SOTA methods and current SOTA error rates, despite decades of searching for an accurate method to do so.

### Utility of BSD

The present inventor confirmed the superiority of BSD by implementing BSD in few-shot LLM inputs. For example, LLM input that included just five deterministically generated input/output pairs outperformed full models trained on over one million non-deterministic pairs.

BSD is the AI breakthrough that the world has been searching for. BSD, combined with MCI disclosed below, even provides 100% accuracy for high level tasks such as Question/Answer and Exposition.

### Novelty of BSD

BSD is not only novel, it is markedly different from other systems and methods. Consider the contrast of BSD with neural networks trained on the WebSplit, WikiSplit, and/or DeSSE datasets for the NLP task of sentence splitting. Here, BSD NLP is literally the opposite.

SOTA Coreference Resolution does not Fulfill BSD Criteria

Coreference Resolution is the NLP task of finding all linguistic expressions in a given text that refer to the same real-world entity. Consider the following example: “Tom walked into the store where he found the bat.” The linguistic expression ‘he’ refers to the same real-world entity ‘Tom.’ Thus, the resolved sentence would read “Tom walked into the store where Tom found the bat.”

On the surface, neural networks trained to perform coreference resolution may appear to be doing so in a deterministic manner. Yet, the current SOTA coreference resolution only has an accuracy of 83.6% (i.e., the Maverick_mes coreference model).

While SOTA coreference models may appear to have been trained in accordance with the above, the reality is that they are neither deterministic (as defined above) nor bounded in scope (as defined above). In other words, they do not meet either criterion-let alone both.

For example, Maverick_mes and other SOTA models (such as lingmess) were trained on a collection of documents known as the OntoNotes corpus. That was largely due to the fact that this document collection contains human annotations for coreference resolution-providing the model known endpoints on which to train. However, rarely discussed is the fact that the human annotators themselves disagreed with each other. The OntoNotes corpus was introduced in a paper entitled “OntoNotes: A Large Training Corpus for Enhanced Processing.” Page 5 of that paper states: “All of the coreference annotation is being doubly annotated and adjudicated. Over the first two years, the overall average agreement between individual annotators and the adjudicated result for non-appositive coreference using the MUC coreference scorer was 86%.”

Researchers only agreed with the selected annotation 86% of the time in regards to standard coreferences. The reference to non-appositive coreferences is a reference to typical types of coreferences. An example of an atypical type (an appositive) is: “My teacher Mrs. Green is a tough grader.” Here, “Mrs. Green” is an appositive coreference to “my teacher.” The researchers treat such appositives as a special case of coreference resolution. Hence, in regards to typical, everyday coreferences, the researchers disagreed with the chosen annotation 14% of the time. Given that humans only agreed 86% of the time, then the dataset most certainly contains a large amount of subjective (i.e., non-deterministic) labels.

The rest of the dataset also includes subjectivity. For example, annotators were told to annotate nouns and verbs 50 sentences at a time. As long as there was 90%+agreement among annotators, the annotations remained as is-without revision and clarification.

“A 50-sentence sample of instances is annotated and immediately checked for inter-annotator agreement for all verbs and any noun with frequency over 100. ITA scores below 90% lead to a revision and clarification of the groupings by the linguist.” (https://www.cs.cmu.cdu/˜hovy/papers/09OntoNotes-GALEbook.pdf) That fact that scores can differ at all means that a deterministic process was not being applied (at least in terms of the way “deterministic” is used herein). The fact that up to 10% disagreement remains unrevised further documents that subjective nature of the process (despite the researchers referring to the allowed 10% discrepancy as being an “empirical process”). Thus, OntoNotes does not meet the determinism requirement of BSD.

Nor does it meet the bounded-scope requirement. The reason for the disagreements is due to the nature of some of the documents. OntoNotes not only contains well-written documents such as news articles, but it also includes broadcasts, “typically recordings of entire shows covering various topics.”

Naturally, people do not always speak using perfectly grammatical sentences-creating occasional confusion as to what they actually mean. (This can even occur in well-thought-out writings as well.)

Thus, the corpus includes a wide range of texts, including those with grammatical errors, and incomplete thoughts, thereby violating the bounded-scope requirement of BSD.

Grammatically correct text can be considered bounded in terms of Sentence Simplification, but it is unbounded in terms of Coreference Resolution.

Even the most complicated sentences must be structured around known grammatical rules. Thus, when splitting sentences, so long as it is done using clauses and prepositions, and provided the sentence is grammatically correct, the sentence can reliably be simplified.

However, coreference resolution is much more complex. Consider an article where “John Smith” is mentioned in the second sentence of paragraph one. The word ‘he’ is used to refer back to John Smith three paragraphs later. There are a large number of complex sentences that can exist between the reference to “John Smith” and the reference to “he.” Moreover, the sentences containing the references may themselves be complex.

So even input/output pairs that finally meet the deterministic requirement, likely will not meet the bounded requirement.

### 100% Accurate BSD Coreference Resolution

One way to reliably bound the problem is by applying BSD Sentence Splitting to the text (producing SS, or “Simplified Sentences”). The SS is then sent to a BSD Coreference Resolution process-a neural network that has been trained to perform coreference resolution on SS_Input/BSD_Target_Output pairs. By solely using BSD Simplified Sentences in the training, the complexity is profoundly reduced-thereby bounding the size of the problem, such that a relatively small neural network can achieve zero as the output from the loss function during training.

Some embodiments may bound the problem size even further by leaving all references at a certain distance unresolved. Training could include supplying five paragraphs of SS in each input of the training set. For example, if the selected maximum distance is five SS sentences, pronouns and other types of coreferences would only be resolved in the target output if the prior reference exists within the prior five SS sentences. Since this is an objective transformation, the neural network can (and will) learn to do the same.

Other embodiments may choose for the target output to be the same as the training input for all instances of ambiguous coreference resolution.

Moreover, BSD embodiments must choose deterministic rules for all nouns and named entities. For example, the embodiment must choose whether the resolution carries forward noun phrases, compound noun phrases, or nested noun phrases. The selected choice must be applied throughout the training dataset. The same goes for the names of people, companies, and even countries (e.g., full country names and/or abbreviation).

So long as the training input is bounded (which is accomplished by using SS), and provided that the target outputs are deterministically derived from each SS, 100% accurate coreference resolution will be achieved. Here, the metric of 100% accurate means that any linguistic elements that are rewritten will be done correctly. It does not mean that every potential linguistic reference will be replaced (for reasons stated above).

### Formatted Facts (FF)

As stated above, BSD Coreference Resolution embodiments can be trained on the output of a BSD Sentence Simplification embodiment. The output of a BSD Sentence Simplification embodiment (SS) can be the training input, and the target output is an objectively transformed derivative of that input (as described above). This can be thought of as the Simple Sentences=>Coreference Resolution pipeline.

Herein, the pipeline of Simple Sentences=>Coreference Resolution shall be referred to as the “FF Pipeline.” FF stands for “Formatted Facts.” This pipeline produces Formatted Facts (FFs) by first simplifying the text (such as using a BSD Sentence Splitting embodiment). (The output of the sentence simplification is called SS. SS stands for “Simplified Sentences.”) The simplified sentences output from the Sentence Simplification process are then used as input to the coreference resolution process (such as a BSD coreference embodiment as described above). Thus, the Sentence Simplification process first produces SS, which is then transformed into Formatted Facts (FF) through the coreference resolution process.

While the preferred embodiment applies Sentence Simplification prior to Coreference Resolution, other embodiments can use the reverse order while remaining within the spirit and scope of this disclosure. The combination of the two processes is a novel method for improving the accuracy of NLP tasks. However, where 100% accuracy is sought, embodiments may first use Sentence Simplification followed by Coreference Resolution.

Moreover, where accuracy is paramount, a BSD Sentence Simplification embodiment is used for the Sentence Simplification process, and a BSD Coreference Resolution embodiment is used for the coreference resolution. In other words, the BSD Sentence Simplification produces the SS, which is then transformed into FF through the BSD Coreference Resolution process.

When BSD processes are used for both, the FF Pipeline can also be referred to as the BSD FF Pipeline to signify the perfect accuracy.

The objective of the BSD FF Pipeline is to transform text into sentences that are both simple and self-contained. The BSD Sentence Splitting=>BSD Coreference Resolution pipeline is often sufficient to transform narrative text into FFs (sentences that are both simple and self-contained). Thus, this represents the simplest FF Pipeline.

### Non-Narrative Converters for Medical, Scientific, Financial, Legal, and Other High-Stakes Texts

Some types of text may require additional processes to meet the FF criteria. For example, some text may include additional elements that are non-narrative (such as caselaw citations, references, and/or LaTeX formulas). In such cases, a Non-Narrative Converter process can be used to strip the non-narrative components. Such a process can create a map (as is known in the art) for adding the removed content back in after the NLP process has been performed. Additionally, or in lieu of a map, the process may insert narrative placeholders to demarcate where the information was removed. Given that the placeholders are narrative, they will pass through the sentence simplification and coreference resolution. The placeholders may be removed after the FFs are created (before sending the text to the NLP process). The placeholder FF output is thus a map for restoring the removed elements after the NLP process has been performed. Those ordinarily skilled in the art know how to construct processes that both strip and restore non-narrative text, and therefore, can implement this inventive step upon learning of it.

The accuracy of virtually all NLP tasks can be profoundly improved using FFs. Consider the high-level NLP process of Summarization as a perfect case in point. Rather than sending the text directly to the summarization process, the output of the BSD FF Pipeline can be sent instead.

### Example

Thus, an example summarization embodiment can include:
electronic text;
an electronic sentence simplification process;
an electronic coreference resolution process;
an electronic summarization process;
in which the text is sent to the sentence simplification process;
the output of the sentence simplification process is sent to the coreference resolution process; and
the output of the coreference resolution process is sent to the summarization process.

By first splitting the sentences, and then applying coreference resolution, the output of the summarization process will be profoundly more accurate.

On the surface, the above may appear trite (rather than profound). However, consider a real-world example. The following sentence is from Wikipedia: “Commander Neil Armstrong and Lunar Module Pilot Buzz Aldrin landed the Apollo Lunar Module Eagle on Jul. 20, 1969, at 20:17 UTC, and Armstrong became the first person to step onto the Moon's surface six hours and 39 minutes later, on July 21 at 02:56 UTC.”

Now consider this sentence transformed into FFs where the BSD Sentence Simplification process deterministically transforms based on clauses and non-causal prepositions using nested noun phrases; and the BSD Coreference Resolution deterministically uses title, first name, last name. Such a pipeline creates the following FFs from the sentence:
Commander Neil Armstrong and Lunar Module Pilot Buzz Aldrin landed the Apollo Lunar Module Eagle.
Commander Neil Armstrong and Lunar Module Pilot Buzz Aldrin landed the Apollo Lunar Module Eagle on Jul. 20, 1969.
Commander Neil Armstrong and Lunar Module Pilot Buzz Aldrin landed the Apollo Lunar Module Eagle at 20:17 UTC.
Commander Neil Armstrong became the first person to step onto the Moon's surface six hours and 39 minutes later.
Commander Neil Armstrong became the first person to step onto the Moon's surface on July 21.
Commander Neil Armstrong became the first person to step onto the Moon's surface at 02:56 UTC.

These simple, self-contained statements have been automatically generated with 100% accuracy from one single sentence using a BSD FF Pipeline.

Whether the NLP task be Summarization, Named Entity Recognition, Question/Answering (QA), Exposition, and more, the accuracy is profoundly improved by sending such FFs in lieu of, and/or in addition to, the original text. While humans prefer pronouns and other contractive linguistic structures, this present inventor discovered machine learning models perform much better on the opposite.

The preferred embodiment for the sentence simplification process is a BSD Sentence Splitting process. The preferred embodiment for the coreference resolution process is a BSD Coreference Resolution process (i.e., a coreference resolution neural network trained on sentences simplified in the precise same manner as the sentence simplification process in the given embodiment).

For optimal accuracy, it is imperative that the Coreference Resolution process be trained on the output of the same embodiment chosen for the BSD Sentence Splitting. In other words, while there are multiple ways to implement BSD Sentence Splitting, whatever way is chosen should be used for the training of the Coreference Resolution process.

The combinations of simplifying sentences and applying coreference resolution on them is novel in that there is no reference to this combination in existing systems and methods. Given that this novel combination affords tremendous utility via improvements in accuracy demonstrates that it is non-obvious (as such improvements in accuracy have been sought for decades without those skilled in the art thinking to modify the input in such a manner).

The above system and method is applicable to virtually any NLP task, such as Named Entity Recognition, Parts of Speech Tagging, and other NLP processes well-known in the art. Any process that takes human language for at least one input is an NLP process for purposes of this present disclosure. Named Entity Identification and Named Entity Recognition are both defined and discussed in detail below. Parts-of-Speech Tagging (POS Tagging) refers to using NLP libraries to identify whether the words in the text are nouns, adjectives, etc. and also in tagging their linguistic dependencies as well. There are many such libraries known in the art (e.g. Stanford NLP, Spacy, and Flair).

For clarification, accuracy can be profoundly increased by sending SSs instead of sending the raw text. Accuracy can be improved even more by sending FFs.

### Example

Hence, one exemplary embodiment of a system for accurate NLP can be as follows:
an electronic sentence simplification process;
an electronic coreference resolution process;
an electronic NLP process;
in which the text is sent to the sentence simplification process;
the output of the sentence simplification process is sent to the coreference resolution process; and
the output of the coreference resolution process is sent to the NLP process.

### Simplification Processes

As stated earlier, FFs are both simple and self-contained. This section focuses on electronic methods of transforming text to meet the first criteria (i.e., processes that make text simpler). Any process used to transform text into simpler sentences shall herein be referred to as a Simplification Process.

Disclosed herein are three novel Sentence Simplification Processes: BSD Sentence Splitting, BSD Sentence Annotation, and Named-Entity Token Substitution.

The previously disclosed BSD Sentence Splitting method can be used as the chosen Simplification Process in various embodiments. Other Sentence Splitting and Rephrasing methods known in the art can be used in lieu of and/or in conjunction with BSD Sentence Splitting. Where accuracy is paramount, BSD Sentence Splitting would be the preferred process. Where speed is more important than accuracy, perhaps a rule-based sentence splitter may be the preferred process. Naturally, processes can be combined to produce a single Simplification Process.

Sentence Splitting and/or Sentence Rephrasing are two examples of processes that electronically simplify text. Any method that reduces the complexity of the input text is a Sentence Simplification Process.

### Sentence Annotation as a Sentence Simplification Process

A novel simplification method disclosed herein is called Noun-Phrase Annotation Process. It is an elegant solution to the myriad of NLP tasks that suffer from inaccuracy, tasks that include not only Summarization and Question/Answer but also the most foundational NLP tasks such as Named Entity Recognition, Parts of Speech Tagging, and Coreference Resolution.

Just as its name suggests, a Noun-Phrase Annotation Process annotates the noun phrases in the text. Importantly, the annotation is consistent and deterministic. For example, noun phrases could be annotated by starting each noun phrase with an underscore, ending each noun phrase with an underscore, and connecting each word in the noun phrase with an underscore. One example alternative would be to annotate the noun phrase minus any preceding determiner (e.g., ‘a’, ‘an’, ‘the’, ‘this’, etc.). Consider five such examples below:
_Mary_bought a _car_.
_Mary_Jenkins_bought a _car_.
_Mary_bought a _brand_new_car_
_Tom_bought a _stunning_, _life-size_photo.
_Tom_Jenkins_of_Deerfield_, _Florida bought a _stunning_, _life-size_photo_signed_by_the_photographer.

The latter example includes a complex noun-phrase (“Tom Jenkins of Deerfield, Florida) as well as a nested noun phrase (“stunning, life-size photo signed by the photographer”). Notice that even though the final sentence is much more complex than the first, the annotation communicates the following to the neural network: _bought a_. In fact, all five examples communicate the very same.

Now consider how this will assist in NLP tasks such as coreference resolution. For example, “Mary bought a car. It was green.” Becomes “Mary bought a car. The car was green.” Likewise consider: “Tom Jenkins of Deerfield, Florida bought a stunning, life-size photo signed by the photographer. It was framed in wood.” This becomes “Tom Jenkins of Deerfield, Florida bought a stunning, life-size photo signed by the photographer. The stunning, life-sized photo signed by the photographer was framed in wood.”

Notice how the annotations reduced the number of deterministic transformations that the neural network needs to learn. Hence, the annotation process assists in bounding the scope of the training. Such bounding profoundly reduces the size of the model required to achieve a 0% loss function output; thereby achieving 100% accuracy on the smallest possible model with shortest possible training time. This optimizes accuracy, speed, and cost all at the same time.

This reduction in deterministic transformation learnings means that the Sentence Annotation Process (SAP) can be used to bound the scope of various high-level NLP tasks to create a BSD Neural Network for that high-level task.

The Sentence Annotation Process (SAP) can be built upon standard libraries such as Spacy and Allen NLP (hereafter referred to as “Spacy”; where “Spacy” is used herein, any suitable NLP library may be substituted). However, the accuracy of the annotation will depend on the accuracy of the aforementioned libraries.

### BSD Sentence Annotation

Where accuracy is paramount, a BSD Sentence Annotation process can include a neural network trained input/output pairs such that the output is deterministically transformed from the input. Example transformations could include annotating noun phrases, annotating complex noun phrases, or annotating nested noun phrases. Provided that the identical objective transformation is used throughout the training set, and provided a sufficient representative sample is provided, and provided the loss function reaches zero during training, a 100% accurate BSD Sentence Annotation Process shall be produced.

The BSD Sentence Annotation could be used at various locations within the BSD FF Pipeline. Upstream BSD processes can be trained on annotated inputs and outputs.

Also, there can be a process for removing annotations in embodiments such as where sending regular text to the user is the objective. Methods for undoing the annotation are well known in the art. For example, removing the “_” (underscore) characters is a trivial process. Such a process shall be referred to as the Sentence Annotation Removal Process.

### Example

Hence, one example embodiment of a system for accurate NLP can be as follows:
a sentence annotation process;
an electronic sentence simplification process;
an electronic coreference resolution process;
a sentence annotation removal process;
an electronic NLP process;
in which:
the sentence simplification process has been trained on annotated input;
the coreference resolution process has been trained on annotated input;
the text is sent to the sentence simplification process;
the output of the sentence simplification process is sent to the coreference resolution process;
the output of the coreference resolution process is sent to the sentence annotation removal process; and
the output of the sentence annotation process is sent to the NLP process.

### Utility of the BSD Sentence Annotation Process

This Noun-Phrase Annotation method profoundly improves accuracy all by itself due to the fact that neural networks take the path of least resistance during the training process. For example, a neural network trained to detect pneumonia in chest X-rays learned to focus on metadata or markers in the images rather than the actual lung features. This occurred because certain hospitals included different markers or annotations in their X-rays, and the model learned to correlate those with the presence of pneumonia.

As another example, a study showed that image classification models like convolutional neural networks (CNNs) trained on the ImageNet dataset tend to rely on texture rather than shape for classification. For example, a neural network might classify a picture of a cat-like object covered in “elephant skin texture” as an elephant. This preference for textures is easier to exploit than learning the shapes and semantics of objects.

Given the importance of this phenomena, consider a final example from dermatology image classification. Models trained to detect skin cancer have relied on artifacts such as rulers or measurement tools often included in malignant samples. A model learned to associate the presence of a ruler with malignancy, a clear shortcut that bypassed the need for true diagnostic reasoning.

The present inventor realized this same form of self-organization found in image-based CNNs also occurs in transformer-based language models. The present inventor also realized that this phenomenon can be transformed from being a problem into being the key to producing smaller models that are profoundly more accurate than larger models 10-100 times their size (even more accurate than models 1,000 times their size).

This led to the novel innovation of BSD Sentence Annotation Process. The annotation process is akin to intentionally adding in the ruler to guide the neural network down the path of least resistance, thereby reducing the number of objective transformations that the neural network needs to learn in order to reach a zero or near zero loss value result. This is not an abstract method. On the contrary, the number of rules with and without the process are quantifiable. For example, the model size and number of training epochs that a coreference resolution machine would need with and without the Noun-Phrase Annotation Process are both quantifiable. The BSD Sentence Annotation can measurably reduce both the model size and number of training epochs needed to reach zero training loss.

The novel innovation of annotating noun phrases comes from the present inventor's epiphany that led to creating the Noun-Phrase Dominance Model. In short, this descriptive framework states that LLMs self-organize around noun phrases during training. Hence, annotating noun-phrases guides the LLM self-organization resulting in extremely powerful, extremely small, extremely inexpensive models.

Once those skilled in the art learn the above, they too can readily implement BSD Simplification Processes with no additional training or disclosure required.

### Named Entity Token Substitution as a Sentence Simplification Process

Named entities are one of the biggest weaknesses of modern LLMs. Named entities refer to the key subjects of a piece of text, such as names, locations, companies, events and products, as well as themes, topics, times, monetary values and percentages. Named Entity Identification (NEI) refers to NLP processes that identify which terms in a given text are named entities. Named Entity Recognition (NER) goes one step farther. This NLP process identifies each named entity and provides a description as to the entity type (e.g., name, location, company, etc.).

Named entities are perhaps best explained by way of example. Consider the following sentence: “Apple acquired XYZ Corp. for $1 billion.” There are three named entities in this example: Apple, XYZ Corp. and $1 billion. As stated above, named entities include names of companies and products as well as monetary values. Named entities also include references to time. Hence, Named Entity Identification (NEI) is also useful in identifying relative time references that need to be converted into absolute time to transform the sentence into a literally true independent statement

For example, LLMs struggle to distinguish “Alfonso” and “Afonso.” They also struggle with dates. In fact, GPT-4 has a 28.6% error rate on the simple task of citing title, author, and year of publication, as these are all named entities.

While LLMs struggle to distinguish “Alfonso” from “Afonso” they have no problem distinguishing between “Chuck” and “Bartholomew.” Experiments conducted by the present inventor identified this phenomenon.

This phenomenon, previously non-obvious to those skilled in the art prior to the present inventor's experiments, holds the key to resolving the above LLM weaknesses.

This present invention discloses a novel process called Token Substitution Process. This section more narrowly focuses on Named Entity Token Substitution Process, where tokens representing named entities are replaced with simpler placeholder tokens before being sent to the NLP process such as an LLM. The placeholder tokens are then replaced back in the NLP process output (e.g., the LLM response).

From the perspective of Token Substitution Processes, “simpler” refers to tokens that are either shorter and/or whose vector embedding distance is greater than the original set.

Named-Entity Token Substitution can include replacing the names of people with a simpler name of the same gender. It can include replacing dates with a simpler token reference, even converting the tokens for “Dec. 25, 2021” into a single in-vocabulary token “Christmas.” In fact, even other dates can be converted to single tokens, including “Christmas” even if they are not “December 25.” So long as Christmas can be converted back to the original date in the text, such will still work in the vast majority of modern LLMs.

Likewise, organizations can be substituted with simpler tokens.

The combination of Sentence Splitting and Token Substitution results in extremely simple sentence structures from the perspective of numerical tokens, making it easy for the NLP process to produce accurate responses. For example, extractive summarization on token-swapped content makes it easier for the Summarization Process to “follow the plot.”

Naturally, swapping out Named Entity Tokens requires first identifying the Named Entities in the text. Thus, this present invention discloses a method of achieving 100% accurate Named Entity Identification (NEI) later below. The 100% accurate Named Entity Identification (NEI) can be used to identify the named entities that can thereafter be swapped with simpler tokens, and then be remapped to the original named entities after receiving the output from the NLP process.

### Noun-Phrase Token Substitution as a Simplification Process

It is the present inventor's discovery that LLMs self-organize around noun phrases.

Therefore, any simplification of noun phrases should result in a corresponding increase in accuracy. This is the premise underlying the above Noun-Phrase Annotation Process.

Noun-Phrase Token Substitution refers to replacing noun-phrases with simpler token representations, in a manner similar to named entities. In fact, named entities are themselves noun phrases, hence the corresponding increase in accuracy.

Consider the following example: “The first car I ever purchased in my lifetime was a Ford.” Annotated such a sentence can be: _The_first_car_I_ever_purchased_in_my_lifetime_ was a _Ford_. “The annotated portion could be reduced to its determiner and root (i.e., “The car”) resulting in the following sentence “The car was a Ford.”

Notice that there is information loss. Therefore, Noun-Phrase Token Substitution is perhaps best used in NLP processes where information loss is acceptable (such as Summarization) and avoided where information loss is unacceptable (such as Question/Answering).

Notice furthermore that Named-Entity Recognition Token Substitution does not result in any information loss (post remapping). Said another way, Named-Entity Token Substitution is a form of Noun-Phrase Token Substitution that results in zero information loss, and therefore, is effective across a broader portion of NLP processes.

A caveat is that the query itself must be substituted in the same manner in NLP processes such as Question/Answering. For example, consider where “Alfonso” is replaced with “Chuck” in the text. Further consider the query: “Who is Alfonso's mother?” The query can be converted to “Who is Chuck's mother?” If the LLM response contains Chuck, then Chuck can be remapped to Alfonso resulting in the correct response.

### Self-Containment Processes

As stated above, FFs are both simple and self-contained. Three example simplification processes have been disclosed above: BSD Sentence Splitting, Sentence Annotation Process, and Token Substitution Process (e.g., Named-Entity Token Substitution Process). Such simplification processes can be used separately or in combination with each other to form the appropriate Sentence Simplification Process for the NLP pipeline. Alternatively, known SOTA simplification methods can be used in lieu of and/or in combination with the novel methods disclosed above.

This section focuses on the self-containment aspect of FFs. Three novel self-containment processes are disclosed herein: BSD Coreference Resolution, Relative-Time Conversion, and First-Person Conversion.

Self-containment stands for creating as many “stand alone” statements from the text as possible. For example, “He sat on a chair” is not a standalone statement because the statement does not define who “he” is. However, “Tom Cruise sat on a chair” is a complete, standalone statement.

Hence, whereas Sentence Splitting leads to simple sentences, Coreference Resolution leads to self-contained sentences. However, certain types of text may require additional and/or alternative processes to produce the maximum number of self-contained statements. Two such types of text are those that contain relative time references and those that contain sentences written in the first person.

Embodiments that process text containing relative time references may use a Relative Time Adjustment process to maximize the number of self-contained statements. Embodiments that process text containing sentences written in the first person may use a First-Person Conversion Process to maximize the number of self-contained statements.

### Relative Date Conversion Process

A Relative Date Conversion Process is an example of a Relative Time Adjustment Process.

Remarkably, chatbots follow the literal meaning of each statement. This is why LLMs often hallucinate regarding time. Consider the following prompt:

Using the supplied Content, write about Mark Zuckerberg attending the conference.

### Content:

Feb. 2, 2020—Mark Zuckerberg will be attending the Meta Conference. He'll be there in three days.

On Mar. 4, 2024, GPT 3.5 Turbo provided the following erroneous response: Mark Zuckerberg, the co-founder and CEO of Meta, will grace the upcoming Meta Conference with his presence. Scheduled to take place in just three days, the conference is expected to be a momentous occasion for industry leaders, tech enthusiasts, and investors alike. (ChatGPT 3.5 Turbo)

ChatGPT Turbo wrongly stated that the event will take place in three days from the time of the prompt (Mar. 4, 2024). The correct response would have been to state: “On Feb. 2, 2020, the event was expected to occur on Feb. 5, 2020.” ChatGPT Turbo's response was wrong.

On Mar. 4, 2024, GPT 4 did not do any better. In fact, in some ways it did even worse:

On Feb. 2, 2020, it was officially announced that Mark Zuckerberg, co-founder and CEO of Facebook, will be attending the Meta Conference. The event takes place in three days, affording Zuckerberg some time to prepare for what promises to be an exciting and educational event. (ChatGPT 4)

One can notice that GPT 4 recognized that the Feb. 2, 2020 announcement was in the past. Nevertheless, it still said that Mark Zuckerberg will be attending three days in the future (i.e., three days from Mar. 4, 2024 rather than three days after Feb. 2, 2020).

The very architecture of training Large Language Models (LLMs) results in the LLM generating text based on the literal meaning of each statement in the input text. The input prompt contained the following statement: “He'll be there in three days.” ChatGPT therefore output a response based on the literal meaning of this independent statement-regardless of the fact that a date was provided-even though GPT 4 recognized the date as being in the past.

### Fixing Time-Based Hallucinations

Time-based hallucinations can be mitigated by programmatically encoding the information with absolute time references. For example, consider the original prompt:

Using the supplied Content, write about Mark Zuckerberg attending the conference.

### Content:

Feb. 2, 2020-Mark Zuckerberg will be attending the Meta Conference. He'll be there in three days.

Instead, consider the result of sending time-encoded information instead:

Using the supplied Content, write about Mark Zuckerberg attending the conference.

### Content:

Feb. 2, 2020-On Feb. 2, 2020, Mark Zuckerberg was expected to attend the Meta Conference. On Feb. 2, 2020, he was expected to attend on Feb. 5, 2020.

Notice how the future verb tense has been encoded as a past-tense expectation, in addition to encoding the data with absolute dates as well. This form of encoding eliminates such time-based hallucinations. For example, on Mar. 10, 2024, ChatGPT 3.5 Turbo responded to the above query as follows:

Mark Zuckerberg, the CEO of Meta, was slated to attend the Meta Conference on Feb. 5, 2020. As an influential figure in the tech industry, his presence at the conference was highly anticipated. Attendees were eager to hear his insights on the future of technology and the direction in which Meta, formerly known as Facebook, was heading.

Not only did the first paragraph properly place the event in the past, but all subsequent sentences of the response did the same.

ChatGPT 4 also properly placed the event in the past: Feb. 2, 2020—This day marked the expectancy of social networking magnate, Mark Zuckerberg's presence at the forthcoming Meta Conference. Conjectures were rife about Zuckerberg gracing the conference that was slated to occur on Feb. 5, 2020. The Meta Conference, gaining attention primarily for Zuckerberg's anticipated attendance, had the industry buzzing with fervor and curiosity.

One step toward accuracy is ensuring that the literal meaning of every individual statement in the context is factually true at the time of the prompt. This is a criterion that must be met to produce hallucination-free responses.

As a reminder, both GPT 3.5 Turbo and GPT 4 produced time-based hallucinations when presented the following prompt:

Using the supplied Content, write about Mark Zuckerberg attending the conference.

### Content:

Feb. 2, 2020—Mark Zuckerberg will be attending the Meta Conference. He'll be there in three days.

The present inventor has seen time-based hallucinations on Perplexity as well.

Also, as documented earlier, neither GPT 3.5 Turbo nor GPT 4 Turbo produced correct responses (in regards to time) when presented the following prompt:

Using the supplied Content, write about Mark Zuckerberg attending the conference.

### Content:

Feb. 2, 2020—On Feb. 2, 2020, Mark Zuckerberg was expected to attend the Meta Conference. On Feb. 2, 2020, he was expected to attend on Feb. 5, 2020.

However, both GPT 3.5 Turbo and GPT 4 embellished (i.e., hallucinated) the information generated outside the context of time. The following prompt resolves this situation for both GPT 3.5 Turbo and GPT 4:

### System:

You accept all the provided Context as true. You answer the prompt solely using the provided context.

Your response solely includes statements that are explicitly conveyed by the context.

Your response does not draw any inferences or implications from the context.

If the provided context does not provide any information related to the prompt then you answer “I don't know.”

### User Prompt:

Using the supplied Content, write about Mark Zuckerberg attending the conference.

### Content:

Feb. 2, 2020—On Feb. 2, 2020, Mark Zuckerberg was expected to attend the Meta Conference. On Feb. 2, 2020, he was expected to attend on Feb. 5, 2020.

By adding the above system prompt, on Mar. 14, 2024, GTP 3.5 Turbo responded: Mark Zuckerberg was expected to attend the Meta Conference on Feb. 5, 2020.

Likewise, on Mar. 14, 2024, GPT 4 responded:

On Feb. 2, 2020, Mark Zuckerberg was expected to attend the Meta Conference on Feb. 5, 2020.

Both models produced 100% accurate, hallucination-free responses. Thus, it is important to instruct the LLMs to solely use the provided context and to not add any inferences or implications.

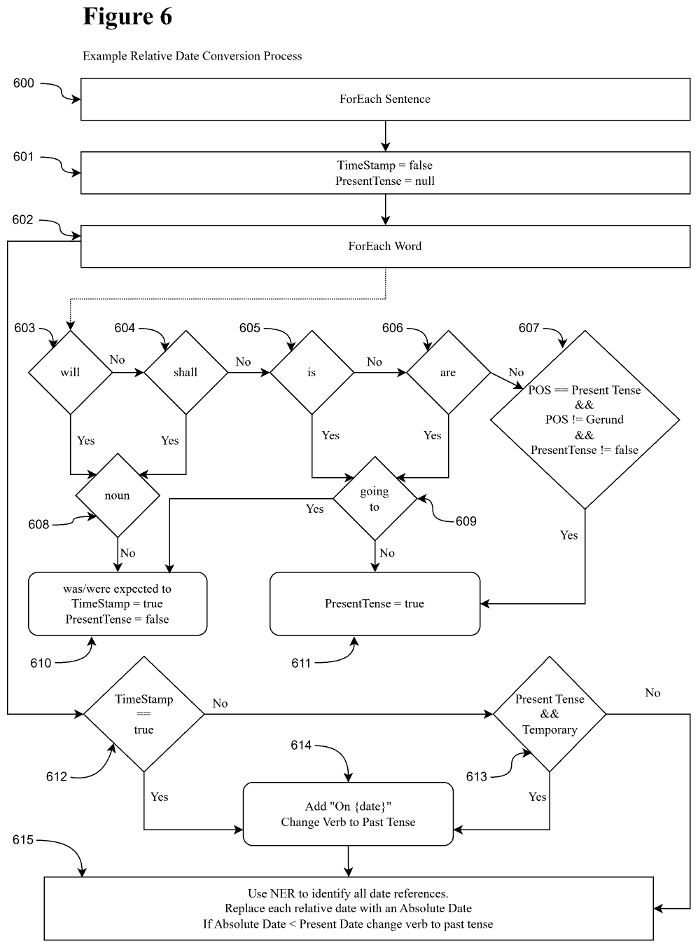

It is also important to encode the time-based references in a manner that fulfills the criteria of FFs. In other words, relative dates need to be replaced with absolute dates on a per statement basis. FIG. 6 illustrates one such embodiment. This embodiment combined off-the-shelf POS Tagging, NER, and relative-to-absolute-date conversion libraries, as are well-known in the art. Those ordinarily skilled in the art can use such libraries to create processes the fulfill the FF criteria.

### Example Embodiment of a Relative Date Conversion Process

FIG. 6 illustrates an example embodiment of a Relative Date Conversion process.

The first step is to divide the text into sentences. Other steps are described as follows:

For each sentence, remove all colloquial references to the present (e.g., remove phrases such as “currently,” “now,” “at present,” “at this current time,” “at this moment,” “right now,” etc.) Standard REGEX expressions can be used in modern programming languages to accomplish this.

For each sentence 600, set TimeStamp to false, and set PresentTense to null 601.

Loop through each word in the sentence 602.

If the current word is ‘will’ 603:

Test to see if the next word is noun 608. If so, do nothing and continue.

If not 608, handle in the same manner as the word ‘shall’ 610.

If the current word is ‘shall’ 604 and the next word is not a noun 608, then do the following 610: if the sentence is plural, replace the current word with ‘were expected to’; if the sentence is singular, replace the current word with ‘was expected to’; set TimeStamp to true; and set PresentTense to false.

If the current word is ‘is’ 605 and the next two words are “going to” 609, then do the following 610: replace “is going to” with “was expected to”; set TimeStamp to true; set PresentTense to false.

Else, if the next two words are not “going to” 609, then just set PresentTense to true 611.

If the current word is ‘are’ 606 and the next two words are “going to” 609, then do the following 610: replace “is going to” with “were expected to”; set TimeStamp to true; set PresentTense to false.

Else, if the next two words are not “going to” 609, then simply set PresentTense to true 611.

If the current word is none of the above and the current word is POS-tagged as PresentTense and the current word is not POS tagged as a Gerund and PresentTense is not false 607, then set PresentTense to true 611.

Once all the words in the sentence have been processed:

If timestamp is true 612 or the sentence is temporary, present tense 613, then add “On {date}” to the beginning of the sentence to timestamp it where date is the date of the document, and change the verb to past tense 614. For example, “Tom is at house” gets encoded as “On Mar. 14, 2024, Tom was at the house”

POS tagging using any standard NLP library can be used to identify whether the sentence is present tense. LLMs can be used to delineate whether the sentence is permanent or temporary. Alternatively, a BSD Neural Network can be trained to perform this task.

For all sentences 615: use NER to locate all date references; for each relative date, use an NLP library known in the art to replace the relative date with an absolute one using the date of the document as the reference point; for each future tense sentence whose computed absolute date is less than the present date: change the verb tense to the past tense.

The above is sufficient information for those skilled in the art to programmatically encode sentences that contain time references in conformity with the criteria of FFs-fully eliminating all-too-common hallucinations caused by relative time references.

### First-Person Conversion Process

This process simply refers to converting first-person sentences to their third-person equivalents. This includes replacing first-person references with the identity of the person. Consider the following example from an email written by Michael Wood on Feb. 10, 2024: “I am going to Publix tomorrow.” The First-Person Conversion Process can rewrite the sentence as follows: “Michael Wood is going to Publix tomorrow.” The sentence can then be further transformed by the Relative Date Conversion Process: “On Feb. 10, 2024, Michael Wood was expected to go to Publix on Feb. 11, 2024”. Notice how the combination of the two processes have methodically transformed a first-person statement into a self-contained statement (the second criteria of an FF).

### Spelling and Grammar Correction Process

A Spelling and Grammar Correction Process can be used to bound the scope. Without such, the neural network would need to be trained on much larger types of inputs to account for misspellings and bad grammar. However, the neural network can be trained on grammatically correct, third-person, narrative text to profoundly reduce the scope.

There are many libraries and API's known in the art for both spelling and grammar correction. Moreover, processes utilizing LLMs can be used as well.

### Example

Hence, one example embodiment of a system for accurate NLP can be as follows:
a sentence annotation process;
an electronic sentence simplification process;
an electronic first-person conversion process;
an electronic coreference resolution process;
an electronic relative-time adjustment process;
a sentence annotation removal process;
an electronic NLP process;
in which:
the sentence simplification process has been trained on annotated input;
the coreference resolution process has been trained on annotated input;
the text is sent to the sentence simplification process;
the output of the sentence simplification process is sent to the first-person conversion process;
the output of the first-person conversion process is sent to the coreference resolution process;
the output of the coreference resolution process is sent to the relative-time adjustment process;
the output of the relative-time adjustment process is sent to the sentence annotation removal process; and
the output of the sentence annotation process is sent to the NLP process.
   Example Accurate NLP Embodiment using Formatted Facts

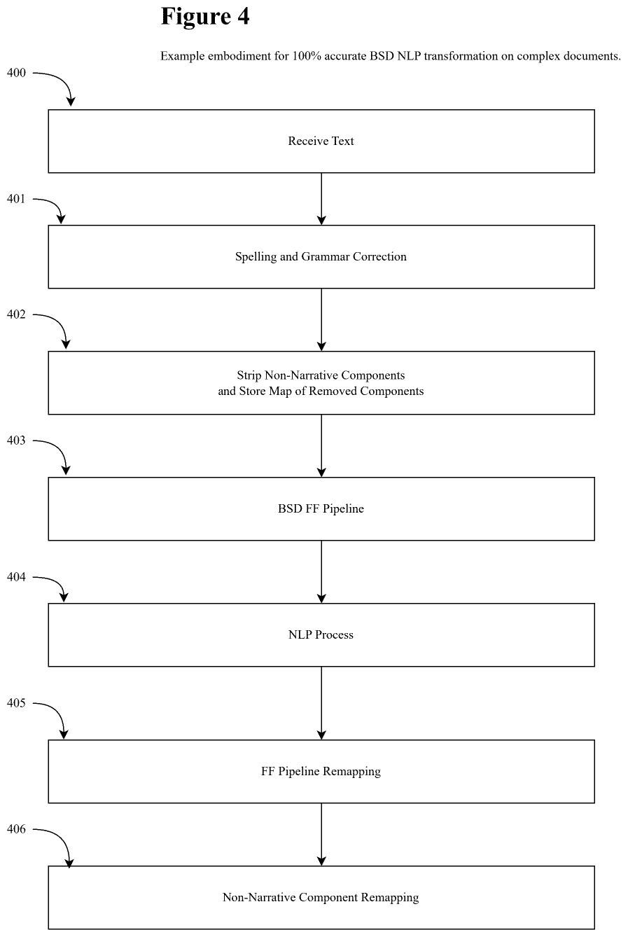

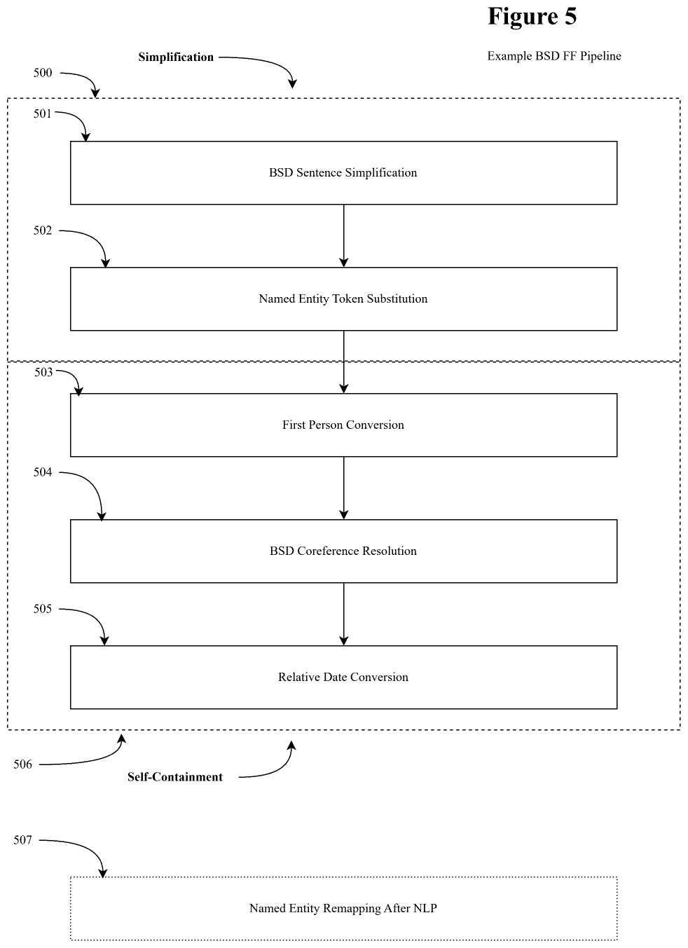

FIG. 4 is an example embodiment for an accurate implementation of an NLP process 404. The embodiment receives text 400. The text is transformed by a Spelling and Grammar Correction Process 401. Non-narrative components are removed using Narrative Converter process 402. The converter strips all parts of the text that are non-narrative. It may also add narrative placeholders to make future reconstruction much easier. Thus, at this state, the text is grammatically correct narration. This text is transformed by the FF Pipeline 403. FIG. 5 illustrates an example FF Pipeline. FIG. 6 illustrates an example embodiment of a Date Conversion Process used in the sample FIG. 5 FF Pipeline embodiment.

The output of the FF Pipeline 403 is sent to the NLP Process 404. Optionally, any narrative placeholders added by the Converter 402 can be stripped from the text before sending to the NLP Process 404. The output of the FF Pipeline 403 is then sent to the FF Pipeline Remapping 404. For example, if any named entities were swapped with single token placeholders in 403 (502), then the placeholders will be replaced with their original named entities 405. Then, any non-narrative components that have been removed will be added in 406.

Other expanded FF Pipelines are disclosed herein.

FFs refer to Formatted Facts which refers to sentences that are both simple and self-contained. FIG. 5 and FIG. 6 illustrate one example embodiment to electronically create FFs from input text. The BSD Sentence Splitting=>BSD Coreference Resolution pipeline is one method of transforming narrative text into FFs with 100% accuracy.

FIG. 5 illustrates an example embodiment of an FF Pipeline. Formatted Facts (FFs) are both simple and self-contained. FIG. 5 illustrates one programmatic way of producing such FFs. The upper dotted box in FIG. 5 shows the sample Simplification Process 500. The lower dotted box in FIG. 5 shows the sample Self-Containment process 506.

In the sample embodiment, the text first undergoes BSD Sentence Simplification 501. This can be a neural network (as in FIGS. 1 and 2) trained on BSD Sentence Simplification outputs (as in FIG. 3). The output of the sentence simplification 501 is sent to the Named Entity Substitution Process 502 where at least one named entity is replaced with a placeholder. The output of the Named Entity Substitution Process 502 is sent to the First Person Conversion Process 503 where sentences written in the first person are converted to their third person equivalents. The output thereof is sent to the BSD Coreference Resolution process 504. The training input for this neural network would be in the same format of the output of the BSD Sentence Simplification process used in the embodiment. The output of the BSD Coreference Resolution process 504 is sent to the Relative Date Conversion Process 505. FIG. 6 illustrates an example embodiment of a Relative Date Conversion Process.

If any named entities were replaced, they would be remapped at 507.

### Introducing Model Correction Interfaces (MCIs)

It is important to note that this present disclosure does not claim that the output of the high-level NLP process will be inherently 100% accurate. While the output of the sentence simplification process can be 100% accurate, and the output of the coreference resolution can be 100% accurate, that does guarantee that the output of the high-level NLP process will be 100% accurate (if the high-level NLP process uses a stochastic or otherwise probabilistic architecture).

In no uncertain terms, the accuracy of the high-level NLP output will be measurably improved, making the above combination useful in its own right.

However, where 100% accuracy is required, all stochastic NLP methods will require the novel innovation of at least one Model Correction Interface (MCI) to ensure 100% accuracy of high-level, stochastic NLP processes.

### Named Entity Recognition Model Correction Interfaces (MCIs)

A Model Correction Interface (MCI) uses deterministic processes to correct known weaknesses in a stochastic and/or otherwise errant NLP process. There are at least three types of MCIs: Adjunctive Model Correction Interface (A-MCI), Bypass Model Correction Interface (B-MCI), and Formatted-Fact Model Correction Interface (FF-MCI). An Adjunctive Model Correction Interface (A-MCI) refers to performing the identical or similar task using at least one additional method that does not have the same weakness as the model being corrected. A Bypass Model Correction Interface (B-MCI) alters the input to bypass a known weakness in the model. A Formatted Facts Model Correction Interface (FF-MCI) replaces the output of the NLP model with known facts (preferably in FF format).

Consider the NLP process of Named Entity Identification (NEI). As explained below, Spacy struggles to correctly identify named entities when they are the first word of a sentence. Thus, another process can be added that specifically identifies named entities for the first word(s) of the sentence. Such would be an Adjunctive Model Correction Interface (A-MCI). Spacy also struggles to identify named entities when words in the sentence are misspelled and/or when the sentence is grammatically incorrect. Thus, the text can first be processed using a Spelling and Grammar Correction process to bypass this weakness. This is an example of Bypass Model Correction Interface (B-MCI). Examples of Formatted Facts Model Interfaces (FF-MCI) are provided in the section immediately below.

### Strengths and Weaknesses of NER Libraries

Off-the-shelf NLP software is excellent at extracting English named entities with one caveat: they are highly dependent on the capitalization of words. For example, Spacy incorrectly handles the following: “Scoular Drives Employee Development With Absorb LMS.” In this instance, Spacy returns “Scoular Drives Employee Development With Absorb” as a single entity instead. This is wrong.

Title casing is very commonly used in news articles, blog posts, and many webpages. Hence, resolving this issue is important for AI systems that incorporate such common sources of information as input.

Title casing is problematic because it capitalizes too many words in regards to the Named Entity Recognition (NER) model's training. On the flipside is the now commonplace practice of using lowercase for everything-most especially when texting or writing emails. As another Stack Overflow user reported, Spacy failed to recognize any named entities in sentences such as: “i love nike shoes from the uk.” However, Spacy correctly identified both Nike and UK as named entities when the following sentence was provided: “i love Nike shoes from the Uk.”

A highly effective, novel approach to solving this issue is to use an LLM to normalize the text before inputting it into the NER resolver. Such normalization is trivial for most LLMs to do. For example, GPT-3.5 Turbo was prompted to remove title casing from “Caribbean Airlines Transforms its Revenue Accounting Process.” The response was: “Caribbean Airlines transforms its revenue accounting process.”

Inputting the normalized response into Spacy's smallest, least-capable model (i.e., en_core_web_sm) results in Caribbean Airlines being correctly identified as a named entity. The model also correctly categorizes Caribbean Airlines as an organization as well.

Likewise, GPT 3.5 Turbo correctly transformed “i love nike shoes from the uk” into “I love Nike shoes from the UK.” Putting GPT 3.5 Turbo's normalized response into Spacy's smallest NLP model resulted in Spacy correctly identifying both Nike and UK as named entities. Spacy also correctly categorized them as an organization and a location respectively.

However, there still remains another important, very common issue that still needs to be resolved. Consider the title-casing example above regarding Scoular. GPT 3.5 turbo correctly transformed “Scoular Drives Employee Development With Absorb LMS” into “Scoular drives employee development with Absorb LMS.” However, when GPT 3.5 Turbo's output was input into Spacy's smallest model, Spacy did not recognize Scoular as a named entity. Spacy only recognized Absorb LMS as a named entity.

The reason is that Scoular is the first word of the sentence. In English, words are typically capitalized when they are used as the first word of a sentence. Experimentations conducted by the present inventor confirmed that Spacy and other NER models often fail to detect named entities when their names are used as the first word of a sentence. Capitalization of the first word is an extremely common case—an extremely common case that profoundly reduces the accuracy of many NLP NEI/NER models.

The truth of the above is confirmed by submitting the following sentence to Spacy: “My best friend works at Scoular.” In this instance, Spacy's smallest model correctly identifies Scoular as a named entity. Moreover, Spacy also correctly categorizes Scoular as an organization.

This demonstration yields some very important distinctions. First, the word Scoular is not in Spacy's vocabulary. If Scoular was in Spacy's vocabulary then Spacy would have recognized it as a named entity even though it was the first word of the sentence. Second, it is demonstrated that Spacy can identify out-of-vocabulary named entities solely by the way the words are used within the sentence.

Naturally it was easy for Spacy to know that Scoular is a named entity due to the capitalization of the word. However, Spacy did more than that. Spacy also correctly categorized Scoular as an organization. The phrase “works at Scoular” allowed Spacy to correctly identify it as an organization-despite the fact that Scoular was not part of the vocabulary. This phrase let Spacy know that Scoular is a place that people work at. This allows the model to correctly categorize Scoular as an organization, even though the word Scoular is something that the model itself contains no information about.

To recap this section so far, it is now established that normalizing capitalization allows NLP NER models such as Spacy to accurately recognize named entities in simple sentences with the exception of when out-of-vocabulary named entities appear at the beginning of a sentence.

### Adjunctive MCI for Named Entity Recognition

As stated above, 100% accuracy can be achieved through BSD neural networks or through using an MCI where stochastic processes are used. An Adjunctive MCI for Spacy NER could include a process that deterministically identifies named entities used at the beginning of sentences.

For example, named entities that are used at the beginning of a sentence have the following linguistic syntax: {Named Entity} {Verb}; or more generically {Noun Phrase} {Verb} where the noun phrase does not begin with a determiner (e.g., “the”, “a”, “an”, “this”, etc.).

Thus, an Adjunctive MCI can use this linguistic structure to identify named entities that appear at the beginning of sentences (measurably improving the accuracy of NEI versus using Spacy alone).

Notice how the Scoular and Caribbean Airlines examples follow this structure.

### Bypass MCI for Named Entity Recognition

Alternatively, the weakness of named entities at the beginning of sentences can be bypassed by searching for sentences that use the same noun phrase in another part of a sentence. This would improve accuracy above using Spacy alone. An internet search API could be employed to accomplish this.

100% Accurate BSD Named Entity Identification (BSD NEI)

The above MCIs address only one Spacy weakness. Where accuracy is paramount, a BSD neural network can be used for 100% accurate NEI.

As stated above, named entities have specific functions in the English language (and other languages as well). Wherever words match such functions, those words are a named entity, even when they are not proper nouns (overcoming the title-casing issue in Spacy as well).

Consider the chemical name for Benadryl: diphenhydramine hydrochloride. Even though it is not capitalized, diphenhydramine hydrochloride is considered a named entity in the context of Named Entity Recognition (NER)-specifically under the category of chemical compounds, drugs, or pharmaceuticals.

This term too follows the linguistic pattern: {Named Entity} {Verb}; and therefore, can be identified as a named entity from any sentence that uses this pattern. It is important to note that it just requires one sentence to identify a named entity. Even if the term is used in 99 sentences without this linguistic pattern, and only one sentence with this pattern, it is the latter sentence that reveals it to be a named entity.

Another pattern may be {Verb} {Noun Phrase} where the noun phrase does not begin with a determiner.

In other words, there are deterministic patterns, and therefore, a BSD neural network can be trained to identify those patterns with 100% accuracy.

The training inputs can be sentences that include at least one of the chosen deterministic patterns (along with training inputs that do not). Where a sentence contains the deterministic pattern, the target output can be all named entities sorted in the order in which they appear in the sentence (the sorting order used in preferred embodiments). As a reminder, BSD Target Outputs can contain multiple values; however, the values must be deterministically sorted to fulfill the BSD criteria.

For training inputs that do not contain the deterministic patterns, a [BLANK] token can be returned (or some other static value that will always be used to signify when no named entity has been found).

Does this mean that BSD will identify every named entity in every sentence all by itself? In no way! However, whenever it says that something is a named entity, that thing is indeed a named entity 100% of the time.

That is another epiphany. Unlike existing systems and methods that attempt to identify every named entity in every sentence, the problem can be reduced to identifying named entities only when there is a deterministic method for doing so. By training a BSD neural network on the deterministic transformation(s), named entities can be mined from text.

### Named Entity Identification Cataloguing

The BSD NEI neural network can be used to text mine named entities. For example, a large portion of the internet is regularly crawled and updated. This internet content is freely available through Common Crawl service. The sentences from Common Crawl can be sent through a BSD NEI neural network to extract all named entities on the web. The named entities can be stored in a database.

The database can also tag the named entity as whether it is also a common noun (such as Apple versus apple). An electronic dictionary can be consulted to determine if the term is also a common noun.

If a term appears in a sentence, and it corresponds to a named entity that is not also a common noun, then the named entity has been identified. If the term is in the database and is also a common noun, the preceding word shall be checked. If there is no preceding word, or the preceding word is not a determiner, then the named entity form of the term is being used.

Thus, BSD NEI neural networks can be used along with the other deterministic processes for 100% accurate Named Entity Identification. This can fully replace Spacy NEI, and other NEI models altogether. Alternatively, POS tagging can be used to identify all noun phrases, which can in turn be processed in the same way above (avoiding having to check for n-gram terms). (N-gram is a term known in NLP.)

### 100% Accurate BSD Hypernym/Hyponym Neural Network (BSD HH)

As stated above, Named Entity Recognition (NER) goes one step farther than Named Entity Identification (NEI). NEI tells whether a term is a named entity; NER does that as well as tell what type of entity the term is.

This is where hypernym/hyponym pairs can be used. In NLP, a hypernym is a word that serves as a general category under which more specific words (i.e., hyponyms) fall. It represents a broader or more abstract concept. A hyponym is a word that represents a more specific instance or subclass of a hypernym.

Consider the following word: dog. Dog is a type of animal. This relationship is expressed in NLP as a hyponym/hypernym pair: dog is the hyponym (the specific instance) and animal is the hypernym (the broader category).

100% accurate NER is achievable through another epiphany: the hypernym of a named entity is a derivative of the entity type. For example, hypernyms for Tom Cruise can include father, actor, etc. All words that refer to people (the entity type for Tom Cruise).

Just as there are deterministic linguistic structures for named entities, there are linguistic structures for identifying hypernym/hyponym relationships. One category of such structures is known as Hearst patterns.

Once again, only deterministic patterns will be used when training a BSD neural network (such as X “is a type of” Y), or {Named Entity} “is a” {Noun Phrase}. The root of Noun Phrase can be used to identify whether the named entity is a person, location, pharmaceutical drug, and more.

Once again, the BSD Neural Network can include examples where [BLANK] is returned, even where hypernym/hyponym relationships exist, but do not match any of the deterministic patterns. Once the BSD neural network has mastered the deterministic patterns, any entity type that it returns can be relied upon.

### Named Entity Recognition Cataloguing

As with BSD NEI, not all sentences will reveal the entity type. However, only one such sentence is needed when cataloguing is used.

It is important to note that the linguistic patterns are very common patterns. Given the immensity of Common Crawl, it is likely that every named entity has many instances of both the NEI and NER patterns.

### 100% Accurate NER: The BSD NEI=>BSD HH Pipeline

BSD NEI can be used to identify and catalogue named entities. Sentences containing identified named entities can be sent to a BSD HH neural network to identify the hypernym for the entity. The hypernym of the entity reveals the entity type.

Every noun in the English dictionary can be assigned an entity type. For example, actor, father, welder, etc., can be assigned PERSON. Words such as city, country, state, and province can be assigned LOCATION or LOC. Various embodiments can determine the entity types they need to support and then assign the words that belong to that type. LLMs can help automate this process.

Thus, after BSD HH neural network identifies the hypernym noun, determining the type of that noun is then as simple as a database or other knowledge base lookup (whether in permanent storage and/or volatile memory).

### Formatted Facts Model Correcting Interfaces (FF-MCI)

The novel inventions of BSD and MCIs are the missing key to 100% accurate NLP. As shown above, BSD can be used for 100% accurate sentence splitting, coreference resolution, named entity identification, named entity recognition, and more.

Equally importantly, BSD is the foundation of Formatted Facts (FFs), as the pipeline of BSD Sentence Simplification=>BSD Coreference Resolution creates Formatted Facts (FFs). FFs are the universal key to accurate QA, Summarization, Exposition, and even Reasoning through the use of Formatted Facts Model Correction Interface (FF MCI).

The definition and implementation of FF-MCI is very precise. An FF-MCI replaces the output of a NLP process with the most similar FFs.

On the surface, this may appear to be the same as “Grounding” that is widely used in the art. However, while Grounding attempts to replace the output with facts, it does not do so in a deterministic manner. The reason for the high error rate in Grounding is the same reason as other NLP tasks. Grounding as practiced in the art is not built upon BSD. Just as sentence splitting and other NLP tasks can achieve 100% accuracy with BSD, so too can Grounding. In other words, FF-MCI provides a universal antidote to hallucinations in one fell swoop.

In one FF-MCI embodiment, the original text is transformed into FFs in accordance with the prior disclosure. These FFs shall be referred to as FFa. The output of a non-deterministic NLP process is also converted to FFs. This shall be referred to as FFb. At least one FFb is then replaced with at least one FFa and/or a deterministically derived transformation of at least one FFa.

There are many methods known in the art for finding the closest FFa to any given FFb, including, but not limited to, using cosine similarity on the vector embeddings of each FF.

An additional step could be to ensure that the chosen FF contains the same nouns and/or synonyms of the nouns. Alternatively, an LLM can be used to verify that the two FFs state identical thoughts. Alternatively, a neural network can be trained on linguistic equivalents. For example:
Training Input: A. The spiciest part of a chili pepper is the pith. B. The part of a chili pepper that is the hottest is the pith.
Target Output: Synonymous
Training Input: A. The spiciest part of a chili pepper is the pith. B. The part of a chili pepper that is the spiciest is the pith.
Target Output: Identical

While such a neural network is not bounded, any errors will solely affect relevancy, not accuracy. In other words, the worst possible scenario is that a suboptimal FFa is chosen. But at least it will be accurate because it is still an FFa.

Should every FFb be replaced with a corresponding FFa, the final result is 100% accurate even if the original output of the non-deterministic NLP process is erroneous. In fact, every single sentence in the NLP process can be erroneous; yet the FF MCI still results in 100% accurate correction.

This FF-MCI embodiment holds the promise of being the holy grail in terms of converting NLP output (including text-based AI output) to 100% correct information.

### Scope Reduction Processes

As discussed above, training a coreference resolution neural network can be bounded by training on the output of a BSD Sentence Simplification Process. In this case, the BSD Sentence Simplification Process serves as a Scope Reduction Process. Also, as previously discussed herein, the Spelling and Grammar Correction Process can be used to reduce the scope for training various NLP neural networks. Such networks can therefore be trained on grammatically correct text, profoundly reducing the scope. This is another example of a Scope Reduction Process. The Sentence Annotation Process is another example of a Scope Reduction Process.

The novel discovery of BSD states that there are two ways to profoundly improve accuracy: 1) bounding the scope; and 2) using target output that is produced by deterministically transforming the corresponding training input. While the combination can be used for 100% accuracy, using either alone will profoundly improve accuracy over those of conventional systems and methods, and therefore, they are both inventive in their own rights.

Thus, embodiments can use Scope Reduction Processes to profoundly increase accuracy of virtually any neural network. An example embodiment can include:
a Scope Reduction Process;
at least one training input dataset;
a neural network;
a neural network training process;
at least one inference input;
wherein the at least one training input dataset contains at least one output of the Scope Reduction Process (or a derivative thereof); and
wherein the neural network is trained on the at least one training input dataset using the neural network training process producing a trained neural network for receiving at least one inference input;
wherein the at least one inference input is sent to the Scope Reduction Process;
where the output is then sent to the trained network.

Notice there is no deterministic target output requirement. Accuracy will be profoundly improved by including at least one Scope Reduction Process during both training and inference. This includes training for virtually all NLP neural networks, including generative chatbots used for creative writing (where there are no deterministic target outputs, as facts are not a consideration).

Other benefits of Scope Reduction Processes are reduced training time and reduced model sizes which result in reduced costs and faster response times. For example, consider a chatbot that only needs to be trained on grammatically correct, third-person text, whose relative dates have already been converted to absolute ones. This would profoundly reduce the number of iterations (i.e., epochs) required for training and allow a much smaller model to produce results superior to a very large one. In this example embodiment, three Scope Reduction Processes are employed: Spelling and Grammar Correction Process, First Person Conversion Process, and Relative Date Conversion Process. The training inputs would be transformed by all three processes. The network would be trained on these transformed inputs. At the time of inference, the inference input can also be transformed by all three processes prior to being sent to the trained network.

Using any of the processes disclosed herein to reduce the bounding scope for training a neural network falls within the spirit and scope of this disclosure. Any Scope Reduction Processes that are obvious based on this disclosure fall within the spirit and scope of this disclosure. Using any Scope Reduction Process for both training and inference falls within the spirit and scope of this disclosure as also does using any Scope Reduction Process to transform human language input for both training and inference.

### BSD NLP Mapping: Universal Bypass MCI

When producing summaries, FFs can be used as input, and the output of the summarization can be sent to the user as is (or corrected with an FF MCI).

However, NLP processes such as parts of speech (POS) tagging and named entity recognition are based on the original sentences themselves. For example, the returned array expressing each part of speech should contain the same number of entries as there are words in the original sentence, also in the same order as the original sentence. This is where BSD NLP Mapping can be used.

The original text is simplified with a BSD Sentence Simplification neural network. The simplified output is sent to the POS library. The output of the POS library is mapped back to the original text. Given that the BSD SS preserves the same words and preserves word order as well, mapping back to the original sentence(s) is trivial to program.

In this manner, BSD NLP Mapping can be used to significantly improve the accuracy of virtually all POS libraries. Hence, any future reference herein to using POS libraries can include using POS libraries by themselves or wrapping such libraries with BSD NLP mapping.

As for named entity recognition (NER), BSD NLP mapping can be conducted as follows: The original text is transformed into FFs using a BSD FF Pipeline. The FFs are sent the (NER) library. The output of the NER library is mapped back to the original text.

Notice that BSD SS is used for POS whereas FFs are used for NER. That is because FFs rewrite pronouns and other references, which would cause information loss for POS. However, the BSD Coreference Resolution component in BSD FF Pipelines simplifies entity relationships, making FFs useful for processes such as NER.

### Foreign Languages

This present disclosure is written in English. Thus, the term foreign language used herein shall refer to any non-English language (such as Spanish, Italian, French, German, etc.). Many foreign languages are structured around noun-phrases as well. Therefore, this present disclosure applies to all languages that are structured around noun-phrases and that also use well-defined named entities—with the topic of named entities being addressed immediately below.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

The creation of any BSD neural network falls within the spirit and scope of this disclosure.

What is claimed is:

1. A bounded scope deterministic system for training a neural network, the system comprising:
a computer and an associated memory;
a neural network comprising at least one trainable parameter;
a training parameter adjustment process for adjusting the at least one trainable parameter;
at least one electronically stored training input;
at least one electronically stored bounded-scope deterministic (“BSD”) target output, wherein each BSD target output is a deterministic transformation of the corresponding at least one electronically stored training input; wherein the neural network transforms each training input of the at least one electronically stored training input based on the at least one trainable parameter to produce at least one training output;
a loss function for computing a cost that measures a deviation between each training output the at least one BSD target output;
wherein if the cost is below a threshold, training of the neural network stops;
wherein if the cost is not below the threshold, (i) the training parameter adjustment process adjusts the at least one trainable parameter to create an adjusted trainable parameter, (ii) the neural network reprocesses the at least one training input using the adjusted trainable parameter to produce at least one new training output, (iii) the loss function again computes the cost based on a deviation between each new training output and the at least one BSD target output, (iv) training stops if the cost is below the threshold, and (v) and if the cost is not below the threshold, another iteration of training is required, wherein the foregoing processes (i) through (iv) are repeated until the cost is below the threshold.

2. The system of claim 1, wherein the neural network's size is large enough to achieve zero or near-zero cost during training.
